(19) United States
(12) Patent Application Publication
(10) Pub. No.: US 2026/0220786 A1
(43) Pub. Date: Jul. 30, 2026

(54) SIGNAL PROCESSING DEVICE, SIGNAL PROCESSING METHOD, AND SENSOR DEVICE

(71) Applicant: SONY SEMICONDUCTOR SOLUTIONS CORPORATION, KANAGAWA (JP)

(72) Inventors: YUKI TAMANO, KANAGAWA (JP); YASUSHI YAMAZAKI, KANAGAWA (JP); KENTAROU OOTSUKA, KANAGAWA (JP); TAKASHI FUJIKAWA, KANAGAWA (JP)

(21) Appl. No.: 19/148,937

(22) PCT Filed: Dec. 6, 2023
(86) PCT No.: PCT/JP2023/043602

§ 371 Date: Jul. 17, 2025

(30) Foreign Application Priority Data
Jan. 26, 2023 (JP) 2023-010329

(51) Int. Cl. G06T 7/13; G06T 7/11; G06V 10/60; H04N 25/47

(52) U.S. Cl. CPC G06T 7/13; G06T 7/11; G06V 10/60; H04N 25/47; G06T 2207/20192

(57) ABSTRACT

A signal processing device according to the present technology includes a first edge emphasis section that inputs an event image that is an image indicating an event detection result by an event detection pixel group including a plurality of event pixels that detect, as an event, a change in an amount of light received by a light receiving element by a predetermined amount or more, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

### TECHNICAL FIELD

The present technology relates to a signal processing device, a method thereof, and a sensor device, and particularly relates to a technical field of image signal processing on an event image that is an image indicating an event detection result by an event detection pixel group that detects, as an event, a change in the amount of received light by a predetermined amount or more.

### BACKGROUND ART

As an image sensor that performs image sensing, an image sensor mounted on a general camera, specifically, an image sensor (hereinafter referred to as a “grayscale sensor”) including, as a pixel array section, a grayscale pixel group including a plurality of grayscale pixels that detect the amount of light received by a light receiving element by a grayscale value of a predetermined level is widely known.

Furthermore, as the image sensor, an image sensor (hereinafter referred to as an “event sensor”) known as a so-called event based vision sensor (EVS) and including, as the pixel array section, an event detection pixel group including a plurality of event pixels that detect, as an event, a change in the amount of light received by a light receiving element by a predetermined amount or more is also known in addition to the grayscale sensor.

Here, in the event sensor, for example, in a case where a foreground subject as a moving object and a background subject thereof have similar colors, in a case where sensing is performed in a dark place, or the like, due to insufficient contrast between the foreground subject and the background subject, an event may not be detected in at least some of pixels in which the event (the change in the amount of received light by the predetermined amount or more) may occurred, and a portion where the detection of the event is missed, in other words, a missing portion may occur in the event image.

For confirmation, the “event image” mentioned here means an image indicating the event detection result by the event detection pixel group, and specifically means information in which information indicating the presence or absence of the detection of the event is associated with every pixel position.

The missing portion in the event image mainly occurs as a missing of a part (or all) of an edge portion such as a contour of the subject as the moving object.

In recent years, there is also a system that executes various kinds of image analysis processing such as recognition processing of the subject, detection processing in a movement direction, and optical flow analysis by using the event image as an input image. In such a case, when the above-described missing portion (missing of the edge portion) occurs in the event image, accuracy of the image analysis processing decreases.

Regarding related conventional technologies, Patent Document 1 below can be cited.

Patent Document 1 discloses a technology of interpolating a missing portion occurring in a grayscale image in a case where an event sensor is configured to generate the grayscale image by reading a light reception signal (luminance value) in a pixel in which the event is detected as well as detecting the event. Specifically, image data (image data G0) including a luminance value read from the pixel in which the event is detected and image data (image data G1) including a luminance value obtained by periodically reading pixels other than the pixel in which the event is detected are superimposed on each other in a frame memory, and a missing portion generated in the image data G0 is interpolated by the image data G1.

### CITATION LIST

### Patent Document

Patent Document 1: Japanese Patent Application Laid-Open No. 2020-136811

### SUMMARY OF THE INVENTION

### Problems to be Solved by the Invention

Here, the interpolation method described in Patent Document 1 is merely a method for interpolating the missing portion of the grayscale image, and cannot interpolate the missing portion of the event image.

Furthermore, in Patent Document 1, since the method for interpolating the missing portion by superimposing the image data G1 on the image data G0 is adopted, portions other than the edge such as the contour of the subject may also be interpolated, and there is a possibility that appropriate edge emphasis cannot be performed.

The present technology has been made in view of the above circumstances, and an object thereof is to improve accuracy of edge emphasis processing of an event image.

### Solutions to Problems

A signal processing device according to the present technology includes a first edge emphasis section that inputs an event image that is an image indicating an event detection result by an event detection pixel group including a plurality of event pixels that detect, as an event, a change in an amount of light received by a light receiving element by a predetermined amount or more, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

The edge emphasis processing on the event image is performed on the basis of the edge direction of the subject detected on the basis of the grayscale image as described above, and thus, it is possible to appropriately interpolate only the missing portion of the edge of the subject.

Furthermore, a signal processing method according to the present technology is a signal processing method including inputting, by a signal processing device, an event image that is an image indicating an event detection result by an event detection pixel group including a plurality of event pixels that detect, as an event, a change in an amount of light received by a light receiving element by a predetermined amount or more, and performing edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

With such a signal processing method, the signal processing device according to the present technology described above can be realized.

Moreover, a sensor device according to the present technology includes a pixel array section in which an event detection pixel group including a plurality of event pixels that detect, as an event, a change in an amount of light received by a light receiving element by a predetermined amount or more is formed, and a first edge emphasis section that inputs an event image that is an image indicating an event detection result by the event detection pixel group in the pixel array section, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

Even with such a sensor device, it is possible to obtain an action similar to that of the signal processing device according to the present technology described above.

### BRIEF DESCRIPTION OF DRAWINGS

FIG. 1 is a block diagram illustrating an internal configuration example of an imaging device as a first embodiment including a signal processing device as a first embodiment according to the present technology.

FIG. 2 is a diagram illustrating a pixel array example of a pixel array section included in a sensor section according to the embodiment.

FIG. 3 is a diagram illustrating an internal configuration example of an event image generation section according to the embodiment.

FIG. 4 is a diagram illustrating a circuit configuration example of an event pixel according to the embodiment.

FIG. 5 is a diagram for explaining an internal configuration example of an output control and reset circuit according to the embodiment.

FIG. 6 is a diagram illustrating an internal configuration example of the sensor section as the first embodiment.

FIG. 7 is a diagram illustrating a luminance signal image and an event image in comparison according to the embodiment.

FIG. 8 is an explanatory diagram of a unit area according to the embodiment.

FIG. 9 is a diagram for explaining an outline of an edge emphasis method as the first embodiment.

FIG. 10 is an explanatory diagram of an edge emphasis direction according to the embodiment.

FIG. 11 is an explanatory diagram of an example of edge emphasis processing according to the embodiment.

FIG. 12 is a flowchart illustrating an example of a specific processing procedure executed by an emphasis area and emphasis direction detection section according to the embodiment.

FIG. 13 is a flowchart illustrating an example of a specific processing procedure executed by an edge emphasis section according to the embodiment.

FIG. 14 is a diagram illustrating a storage example of edge emphasis-related information according to the embodiment.

FIG. 15 is a diagram illustrating another storage example of the edge emphasis-related information according to the embodiment.

FIG. 16 is a diagram illustrating still another storage example of the edge emphasis-related information according to the embodiment.

FIG. 17 is a diagram for explaining a configuration example and an operation example of an image use processing section in a case where a calculation load is reduced by using the edge emphasis-related information.

FIG. 18 is a block diagram illustrating an internal configuration example of a sensor section as a second embodiment.

FIG. 19 is a diagram for explaining an operation example in a case where edge emphasis of a grayscale image is performed on the basis of an edge direction detected on the basis of an event image after edge emphasis.

FIG. 20 is a block diagram illustrating an internal configuration example of a sensor section as a third embodiment.

FIG. 21 is an explanatory diagram of a binarized image.

FIG. 22 is a block diagram illustrating an internal configuration example of a sensor section as a modification in which edge direction detection is performed for a binarized image.

FIG. 23 is an explanatory diagram of a modification according to a pixel array pattern in a pixel array section.

FIG. 24 is a diagram illustrating an internal configuration example of an imaging device as a modification in which a grayscale sensor and an event sensor are separately provided.

FIG. 25 is a diagram for explaining an internal configuration example of each of a grayscale sensor section and an event sensor section in a case where the configuration of the imaging device illustrated in FIG. 24 is adopted.

### MODE FOR CARRYING OUT THE INVENTION

Hereinafter, embodiments according to the present technology will be described in the following order with reference to the accompanying drawings.
<1. First Embodiment>
(1-1. Configuration of Imaging Device)
(1-2. Sensor Section as First Embodiment)
(1-3. Processing Procedure)
(1-4. About Edge Emphasis-related Information)
<2. Second Embodiment>
<3. Third Embodiment>
<4. Modifications>
<5. Summary of Embodiment>
<6. Present Technology>

### 1. First Embodiment

### 1-1. Configuration of Imaging Device

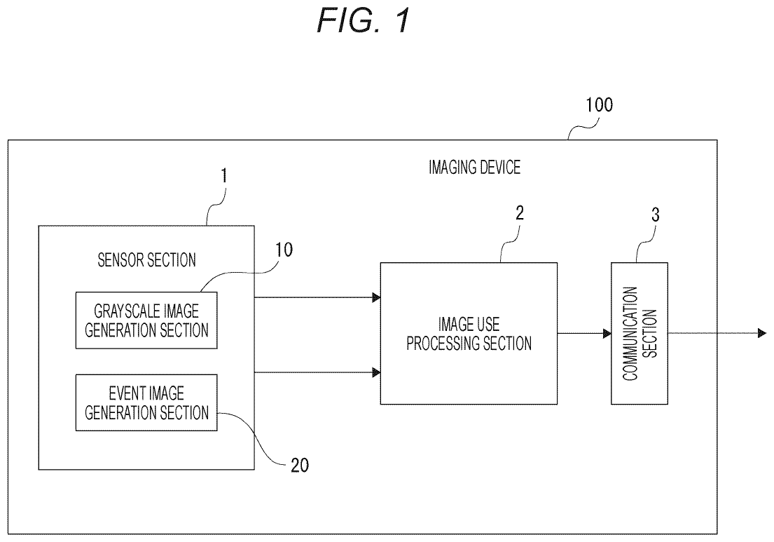

FIG. 1 is a block diagram illustrating an internal configuration example of an imaging device 100 as a first embodiment including a signal processing device as the first embodiment according to the present technology.

As illustrated in FIG. 1, the imaging device 100 as the first embodiment includes a sensor section 1, an image use processing section 2, and a communication section 3.

The sensor section 1 includes a grayscale image generation section 10 and an event image generation section 20, and is configured to be able to generate a grayscale image and an event image.

Here, the grayscale image means an image obtained by a grayscale pixel group including a plurality of grayscale pixels that detect the amount of light received by a light receiving element by a grayscale value of a predetermined level.

Furthermore, the event image means an image indicating a detection result of an event in units of pixels. The event mentioned here means a change in the amount of light received by the light receiving element by a predetermined amount or more.

In the present embodiment, the sensor section 1 has a configuration as a so-called mixed sensor in which an event pixel group including a plurality of event pixels for detecting an event and a grayscale pixel group are mixed in a pixel array section 1a.

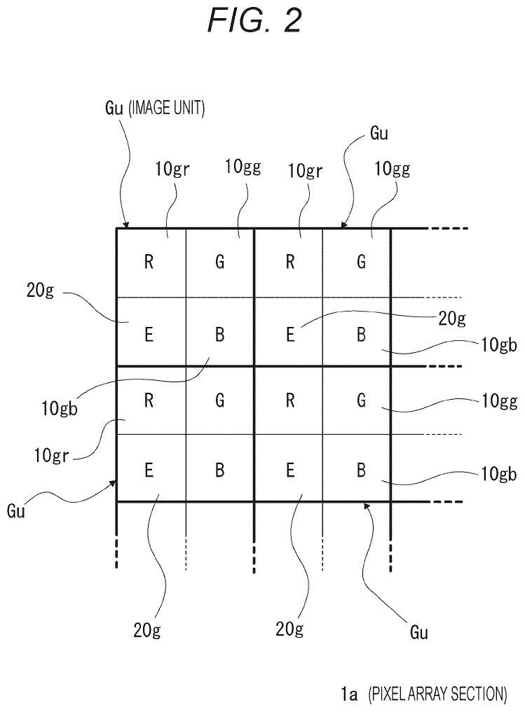

FIG. 2 illustrates a pixel array example of the pixel array section 1a included in the sensor section 1.

As illustrated in the drawing, in the pixel array section 1a, grayscale pixels 10g and event pixels 20g that detect an event are arrayed in a predetermined array pattern. In the present example, in order to enable generation of a color image as the grayscale image, grayscale pixels 10gr, 10gg, and 10gb corresponding to colors of red (R), green (G), and blue (B) are formed as the grayscale pixels 10g. The grayscale pixel 10gr can selectively receive R light, the grayscale pixel 10gg can selectively receive G light, and the grayscale pixel 10gb can selectively receive B light.

In the pixel array section 1a of the present example, a plurality of pixel units Gu each including one grayscale pixel 10gr, one grayscale pixel 10gg, one grayscale pixel 10gb, and one event pixel 20g two-dimensionally arrayed in a predetermined pattern are two-dimensionally arrayed. Specifically, the pixel unit Gu in the present example includes the number of pixels in a horizontal direction (horizontal line direction)×the number of pixels in a vertical direction=2×2=4 pixels. The grayscale pixel 10gr and the grayscale pixel 10gg are arranged adjacent to each other in the horizontal direction and the event pixel 20g and the grayscale pixel 10gb are arranged adjacent to each other in the horizontal direction. The grayscale pixel 10gr and the event pixel 20g are arranged adjacent to each other in the vertical direction and the grayscale pixel 10gg and the grayscale pixel 10gb are arranged adjacent to each other in the vertical direction.

Note that, the pixel array pattern in the pixel unit Gu is not limited thereto, and it is also conceivable to adopt another array pattern.

As can be seen with reference to FIG. 2, in the sensor section 1 of the present example, a plurality of grayscale pixels 10g are formed as the grayscale pixel group in the pixel array section 1a, and a plurality of event pixels 20g are formed as the event pixel group.

Although not illustrated, since light from a subject is incident on the pixel array section 1a via an imaging lens, the grayscale pixel group and the event pixel group receive light from the subject via a common imaging lens.

In FIG. 1, the grayscale image generation section 10 generates the grayscale image on the basis of grayscale values (light reception signal values) detected by the grayscale pixels 10gr, 10gg, and 10gb in the pixel array section 1a. In the present example, it is assumed that the grayscale image generated by the grayscale image generation section 10 is a RAW image before demosaic processing.

As will be described later, in the sensor section 1 of the present example, the demosaic processing is performed on the grayscale image as the RAW image generated by the grayscale image generation section 10 to output as an input image of the image use processing section 2.

Note that, it is also conceivable to output the RAW image as it is from the sensor section 1, and perform demosaic processing on the image use processing section 2 side.

The event image generation section 20 generates an event image that is an image indicating a detection result of an event by an event detection pixel group in the pixel array section 1a. Specifically, the event image is information indicating at least the presence or absence of occurrence of an event for every event pixel 20g.

The event image generation section 20 in the present example generates an event image in a predetermined frame cycle. That is, an image indicating the presence or absence of the detection of the event in each event pixel 20g is generated every certain period as a frame period. In the present example, the frame cycle of the event image is shorter than a frame cycle of the grayscale image, and is, for example, at least 1/10 or less of the frame cycle of the grayscale image.

Furthermore, the event image generation section 20 in the present example is configured to be able to detect, as events, a “positive electrode event” that is an increasing-side change of amount of received light by a predetermined amount or more and a “negative electrode event” that is a decreasing-side change of the amount of received light by a predetermined amount or more. That is, as the event image in this case, an image indicating the presence or absence of the occurrence of the positive electrode event and an image indicating the presence or absence of the occurrence of the negative electrode event for every event pixel 20g are generated.

Note that, an internal configuration of the event image generation section 20 will be described again.

Furthermore, a circuit section (an edge emphasis section 15 as described later) that performs edge emphasis processing on the event image generated by the event image generation section 20 is provided in the sensor section 1, and this will be described again.

The image use processing section 2 performs image analysis processing using, as an input image, at least the event image output from the sensor section 1. The image use processing section 2 in the present example performs image analysis processing using, as the input image, not only the event image but also the grayscale image (in the present example, the grayscale image after the demosaic processing) output from the sensor section 1. Note that, the image analysis processing here is also conceivable to be processing using artificial intelligence (AI).

Examples of the image analysis processing here include recognition processing of the subject, detection processing in a movement direction, and processing of optical flow analysis.

The communication section 3 performs wired or wireless data communication with an external device of the imaging device 100. The communication section 3 can output information indicating an image analysis result by the image use processing section 2 to the external device of the imaging device 100.

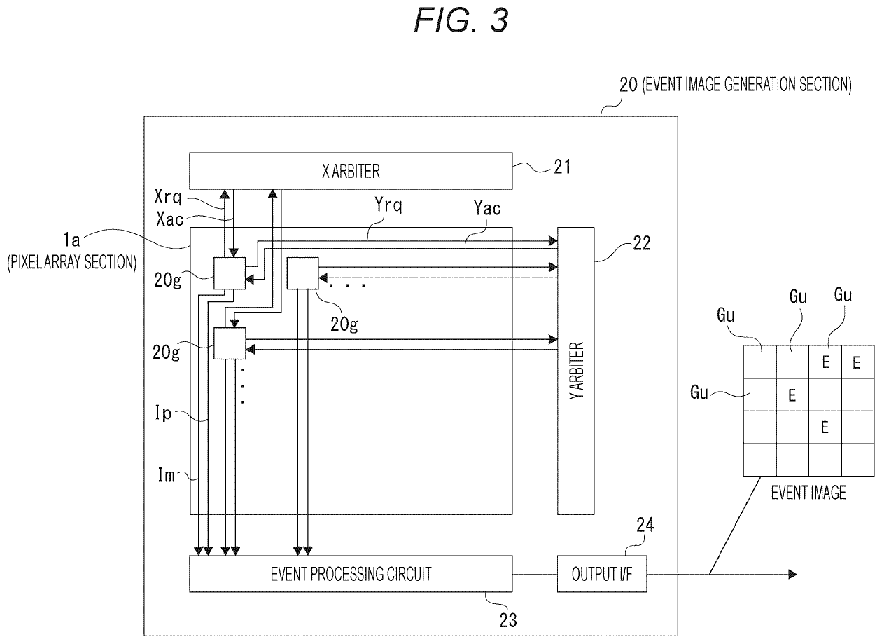

FIG. 3 is a diagram illustrating the internal configuration example of the event image generation section 20.

As illustrated in the drawing, the event image generation section 20 includes the plurality of event pixels 20g as the event pixel group in the pixel array section 1a, an X arbiter 21 and a Y arbiter 22, an event processing circuit 23, and an output interface (I/F) 24.

Each event pixel 20g includes a light receiving element, and is configured to be able to detect an event that is a change in the amount of received light by a predetermined amount or more. Each event pixel 20g in the present example is configured to be able to detect, as the events, the positive electrode event and a negative electrode event.

In a case where the event is detected regardless of the positive electrode event or the negative electrode event, each event pixel 20g outputs request signals for requesting reading (outputting) of an event signal from the event pixel itself to the X arbiter 21 and the Y arbiter 22. As illustrated in the drawing, the request signal for the X arbiter 21 is a “request signal Xrq”, and the request signal for the Y arbiter 22 is a “request signal Yrq”.

Then, each event pixel 20g outputs an event signal according to arbitration by the X arbiter 21 and the Y arbiter 22 corresponding to the request signals Xrq and Yrq. Specifically, in response to reception of a response signal Xac output from the X arbiter 21 as a response (ACK) to the request signal Xrq and a response signal Yac output from the Y arbiter 22 as a response to the request signal Yrq, each event pixel 20g outputs a positive-electrode-side event signal Ip that is a signal indicating a detection result of the positive electrode event and a negative-electrode-side event signal Im that is a signal indicating a detection result of the negative electrode event to the event processing circuit 23.

The X arbiter 21 and the Y arbiter 22 arbitrate the request signals (the request signals Xrq and Yrq described above) from each event pixel 20g and transmit, as the response signals (Xac and Yac), a response based on the arbitration result (permission or non-permission of the output of the event signal) to the event pixel 20g which is an output source of the request signal.

The event processing circuit 23 generates event data for the event pixel 20g on the basis of the event signals (in the present example, positive-electrode-side event signal Ip and negative-electrode-side event signal Im) input from the event pixel 20g.

As the event data, data including at least positional information (address information in a pixel coordinate system: hereinafter referred to as “positional information of an event occurring pixel”) of the event pixel 20g in which the event is detected and “detection time information” indicating a detection time of the event is generated. In the present example, since the positive electrode event and the negative electrode event can be detected as the events, in order to cope with these events, data including “event type information” which is information indicating a type of the detected event (the positive electrode event or the negative electrode event) is generated as the event data together with the positional information and the detection time information of the event occurring pixel described above.

The output I/F 24 sequentially outputs the event data output in units of rows from the event processing circuit 23 to an outside.

The output I/F 24 outputs an event image indicating an event detection result for every coordinates of the pixel unit Gu as illustrated in the drawing.

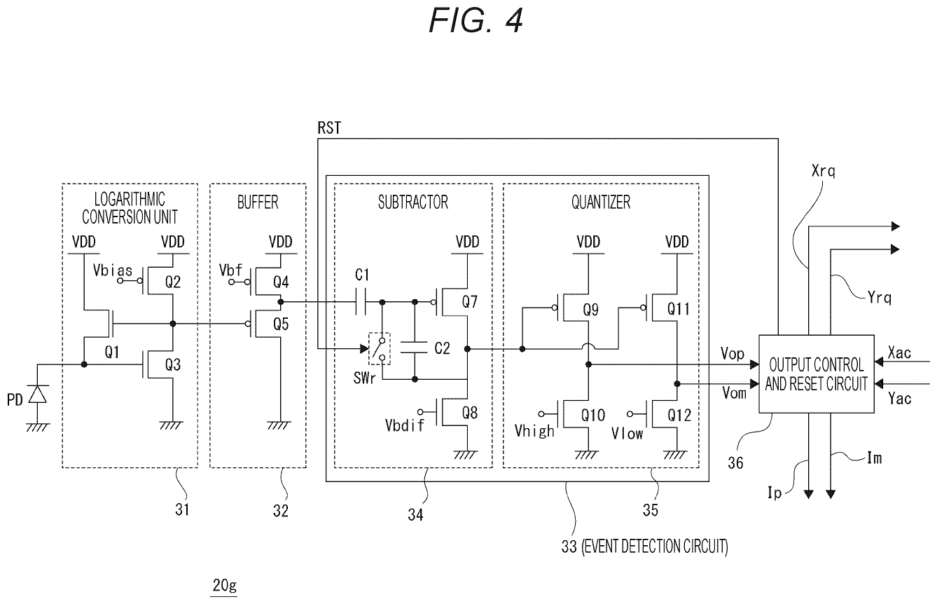

FIG. 4 is a diagram illustrating a circuit configuration example of the event pixel 20g.

As illustrated in the drawing, the event pixel 20g includes a photodiode PD as the light receiving element, a logarithmic conversion section 31, a buffer 32, an event detection circuit 33, and an output control and reset circuit 36.

In the event pixel 20g, a charge accumulated in the photodiode PD is transferred to the logarithmic conversion section 31. The logarithmic conversion section 31 converts a photocurrent (current corresponding to the amount of received light) obtained by the photodiode PD into a voltage signal of the logarithm.

The buffer 32 corrects the voltage signal input from the logarithmic conversion section 31 and outputs the corrected voltage signal to the event detection circuit 33.

As illustrated in the drawing, the logarithmic conversion section 31 includes a transistor Q1, a transistor Q2, and a transistor Q3.

Here, in the present example, metal-oxide-semiconductor field-effect transistors (MOSFETs) are used for the various transistors Q included in the event pixel 20g.

In the logarithmic conversion section 31, the transistors Q1 and Q3 are N-type transistors, and the transistor Q2 is a P-type transistor.

A source of the transistor Q1 is connected to a cathode of the photodiode PD, and a drain thereof is connected to a power supply terminal (reference potential VDD). The transistor Q2 and the transistor Q3 are connected in series between the power supply terminal and a ground terminal. Furthermore, a connection point between the transistor Q2 and the transistor Q3 is connected to a gate of the transistor Q1 and an input terminal of the buffer 32 (a gate of a transistor Q5 as described later). Furthermore, a predetermined bias voltage Vbias is applied to a gate of the transistor Q2.

Drains of the transistor Q1 and the transistor Q3 are connected to the power supply side (reference potential VDD), and a source follower circuit is formed. The photocurrent from the photodiode PD is converted into the logarithmic voltage signal by these two source followers connected in a loop shape. Furthermore, the transistor Q2 supplies a constant current to the transistor Q3.

The buffer 32 includes a transistor Q4 and a transistor Q5 which are P-type transistors, and the transistors Q4 and Q5 are connected in series between the power supply terminal and the ground terminal.

A connection point between the transistor Q4 and the transistor Q5 is set as an output terminal of the buffer 32, and a corrected voltage signal is output as a light reception signal from the output terminal to the event detection circuit 33.

The event detection circuit 33 detects, as the event, the change in the amount of received light by obtaining a difference from a current level of the light reception signal using a past level of the light reception signal as a reference level Lref. Specifically, the event detection circuit 33 detects the presence or absence of the occurrence of the event on the basis of whether or not a level (absolute value) of a difference signal representing the difference between the reference level Lref and the current level of the light reception signal is equal to or greater than a predetermined threshold.

The event detection circuit 33 of the present example is configured to be able to separately detect the positive electrode event, that is, an event in which the difference from the reference level Lref is positive and the negative electrode event, that is, an event in which the difference from the reference level Lref is negative.

The event detection circuit 33 generates a positive-electrode-side output voltage Vop as an output voltage indicating a detection result of the positive electrode event and a negative-electrode-side output voltage Vom as an output voltage indicating a detection result of the negative electrode event.

Here, the event detection circuit 33 resets the reference level Lref to the current level of the light reception signal on the basis of a reset signal RST as described later.

The reference level Lref is reset in this manner, and thus, it is possible to detect a new event on the basis of a change in a light reception signal level from a point in time when the reset is performed. That is, the reset of the reference level Lref is equivalent to returning the event detection circuit 33 to a state where the new event can be detected.

The event detection circuit 33 includes a subtractor 34 and a quantizer 35.

The subtractor 34 decreases the level of the light reception signal (voltage signal) from the buffer 32 according to the reset signal RST, and outputs the decreased light reception signal to the quantizer 35.

The quantizer 35 quantizes the light reception signal from the subtractor 34 and obtains an output voltage indicating a quantization result. Specifically, in the present example, the positive-electrode-side output voltage Vop and the negative-electrode-side output voltage Vom are obtained.

The subtractor 34 includes a capacitor C1 and a capacitor C2, a transistor Q7 and a transistor Q8, and a reset switch SWr. The transistor Q7 is a P-type transistor, and the transistor Q8 is an N-type transistor.

The transistor Q7 and the transistor Q8 are connected in series between the power supply terminal and the ground terminal to form an inverter. Specifically, a source of the transistor Q7 is connected to the power supply terminal, a drain thereof is connected to a drain of the transistor Q8, and a source of the transistor Q8 is connected to the ground terminal. Note that, a voltage Vbdif is applied to a gate of the transistor Q8.

The capacitor C1 has one end connected to an output terminal of the buffer 32 and the other end connected to a gate (input terminal of the inverter) of the transistor Q7. The capacitor C2 has one end connected to the other end of the capacitor C1 and the other end connected to a connection point between the transistor Q7 and the transistor Q8.

The reset switch SWr has one end connected to a connection point between the capacitor C1 and the capacitor C2 and the other end connected to a connection point between the transistor Q7 and the transistor Q8 and a connection point between the transistor Q7 and the capacitor C2, and is connected in parallel to the capacitor C2. The reset switch SWr is a switch that is turned on or off according to the reset signal RST.

The inverter including the transistor Q7 and the transistor Q8 inverts the light reception signal input via the capacitor C1 and outputs the inverted light reception signal to the quantizer 35.

Here, in the subtractor 34, a potential generated on the buffer 32 side of the capacitor C1 at a certain point in time is set as a potential Vinit. Then, it is assumed that the reset switch SWr is turned on at this time. In a case where the reset switch SWr is turned on, a side of the capacitor C1 opposite to the buffer 32 is a virtual ground terminal. A potential of the virtual ground terminal is assumed to be zero for the sake of convenience. At this time, when a capacitance of the capacitor C1 is denoted by Cp1, a charge CHinit accumulated in the capacitor C1 is expressed by the following [Expression 1].

$$CHinit = Cp 1 \times Vinit \qquad [ Expression 1 ]$$

Furthermore, when the reset switch SWr is turned on, since both ends of the capacitor C2 are short-circuited, the accumulated charge becomes zero.

Next, it is assumed that the reset switch SWr is turned off. When there is the change in the amount of received light, the potential on the buffer 32 side of the capacitor C1 is changed from Vinit described above. When a potential after the change is denoted by Vafter, a charge CHafter accumulated in the capacitor C1 is expressed by the following [Expression 2].

$$CHafter = Cp 1 \times Vafter \qquad [ Expression 2 ]$$

On the other hand, when a capacitance of the capacitor C2 is denoted Cp2 and an output voltage of the subtractor 34 is denoted Vout, a charge CH2 accumulated in the capacitor C2 is expressed by the following [Expression 3].

$$CH 2 = - Cp 2 \times Vout \qquad [ Expression 3 ]$$

At this time, since a total amount of charges of the capacitors C1 and C2 do not change, the following [Expression 4] is established.

$$CHinit = CHafter + CH 2 \qquad [ Expression 4 ]$$

When [Expression 1] to [Expression 3] are substituted into [Expression 4] and [Expression 4] is transformed, the following [Expression 5] is obtained.

$$Vout = - ( Cp 1 / Cp 2 ) \times ( Vafter - Vinit ) \qquad [ Expression 5 ]$$

[Expression 5] represents a subtraction operation of the voltage signal, and a gain of a subtraction result is Cp1/Cp2.

From this [Expression 5], it can be seen that the subtractor 34 outputs a signal representing the difference between the past level (Vinit) of the light reception signal and the current level (Vafter) of the light reception signal.

Here, the potential Vinit corresponds to the reference level Lref described above. From the above description, the reset switch SWr is turned on, and thus, the potential Vinit, that is, the reference level Lref is reset to the current level of the light reception signal, in other words, the level of the light reception signal at a point in time when the reset switch SWr is turned on.

The quantizer 35 includes a transistor Q9, a transistor Q10, a transistor Q11, and a transistor Q12, and is constituted as a 1.5 bit quantizer.

The transistors Q9 and Q11 are P-type transistors, and the transistors Q10 and Q12 are N-type transistors.

As illustrated in the drawing, the transistor Q9 and the transistor Q10, and the transistor Q11 and the transistor Q12 are connected in series between the power supply terminal and the ground terminal, and the output voltage (Vout) of the subtractor 34 is input to each gate of the transistors Q9 and Q11. Furthermore, a voltage Vhigh is applied to a gate of the transistor Q10, and a voltage Vlow is applied to a gate of the transistor Q12.

The positive-electrode-side output voltage Vop indicating the detection result of the positive electrode event is obtained at a connection point between the transistor Q9 and the transistor Q10, and the negative-electrode-side output voltage Vom indicating the detection result of the negative electrode event is obtained at a connection point between the transistor Q11 and the transistor Q12.

Specifically, on the transistors Q9 and Q10 side, in a case where a level of the output voltage (Vafter−Vinit) of the subtractor 34 is equal to or higher than a threshold on a positive side corresponding to the voltage Vhigh, the positive-electrode-side output voltage Vop at an H level is obtained at the connection point between the transistor Q9 and the transistor Q10, and in a case where the level of the output voltage of the subtractor 34 is less than the threshold on the positive side, the positive-electrode-side output voltage Vop at an L level is obtained. That is, at the connection point between the transistor Q9 and the transistor Q10, a signal indicating whether or not the amount of received light changes by a predetermined threshold or more in an increasing direction, that is, the positive-electrode-side output voltage Vop indicating the detection result of the positive electrode event is obtained.

Furthermore, on the transistors Q11 and Q12 side, in a case where the level of the output voltage of the subtractor 34 is equal to or lower than a threshold on a negative side corresponding to the voltage Vlow, the negative-electrode-side output voltage Vom at the H level is obtained at the connection point between the transistor Q11 and the transistor Q12, and in a case where the level of the output voltage of the subtractor 34 is higher than the threshold on the negative side, the negative-electrode-side output voltage Vom at the L level is obtained. As described above, at the connection point between the transistor Q11 and the transistor Q12, a signal indicating whether or not the amount of received light changes by a predetermined threshold or more in a decreasing direction, that is, the negative-electrode-side output voltage Vom indicating the detection result of the negative electrode event is obtained.

The output control and reset circuit 36 performs the output of the request signals Xrq and Yrq for the above-described X arbiter 21 and Y arbiter 22, the output of the positive-electrode-side event signal Ip and the negative-electrode-side event signal Im corresponding to the response signals Xac and Yac, and the output of the reset signal RST for the reset switch SWr.

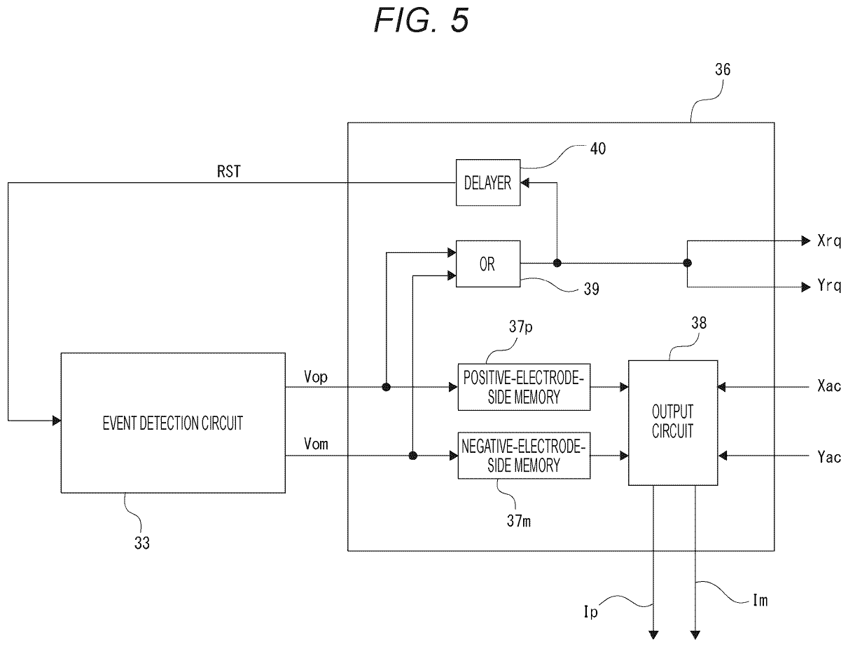

FIG. 5 is a diagram for explaining an internal configuration example of the output control and reset circuit 36, and illustrates the event detection circuit 33 together with the internal configuration example of the output control and reset circuit 36.

The output control and reset circuit 36 includes a positive-electrode-side memory 37p, a negative-electrode-side memory 37m, an output circuit 38, an OR circuit 39, and a delayer 40.

The positive-electrode-side output voltage Vop from the event detection circuit 33 is input to the OR circuit 39 in addition to being retained in the positive-electrode-side output voltage Vop. Furthermore, the negative-electrode-side output voltage Vom from the event detection circuit 33 is input to the OR circuit 39 in addition to being retained in the negative-electrode-side memory 37m.

Here, the positive-electrode-side memory 37p and the negative-electrode-side memory 37m retain values (digital values) corresponding to voltage levels of the input positive-electrode-side output voltage Vop and negative-electrode-side output voltage Vom. Specifically, in the present example, “1” is retained when the voltage levels of the positive-electrode-side output voltage Vop and the negative-electrode-side output voltage Vom are the H level, and “0” is retained when the voltage levels are the L level.

The OR circuit 39 outputs a signal at the H level in a case where at least one of the input positive-electrode-side output voltage Vop or the input negative-electrode-side output voltage Vom is at the H level, and outputs a signal at the L level in a case where both the input positive-electrode-side output voltage Vop and input negative-electrode-side output voltage Vom are at the L level. That is, the OR circuit 39 sets the output signal to the H level in response to the detection of one of the positive electrode event and the negative electrode event, and sets the output signal to the L level in a case where both the events are not detected.

Such output signals from the OR circuit 39 are transmitted as the above-described request signals Xrq and Yrq to the X arbiter 21 and the Y arbiter 22.

In response to the input of both the response signal Xac from the X arbiter 21 and the response signal Yac from the Y arbiter 22, the output circuit 38 outputs, as the positive-electrode-side event signal Ip and the negative-electrode-side event signal Im, the value retained in the positive-electrode-side memory 37p and the value retained in the negative-electrode-side memory 37m to the event processing circuit 23.

In a case where the positive electrode event is detected, “1” is output as the positive-electrode-side event signal Ip and “0” is output as the negative-electrode-side event signal Im, and the event processing circuit 23 can specify that the positive electrode event is detected in the corresponding event pixel 20g. On the other hand, in a case where the negative electrode event is detected, “0” is output as the positive-electrode-side event signal Ip and “1” is output as the negative-electrode-side event signal Im, and the event processing circuit 23 can specify that the negative electrode event is detected in the corresponding event pixel 20g.

The delayer 40 delays the output signal from the OR circuit 39 and outputs, as the reset signal RST, the delayed output signal to the event detection circuit 33 (reset switch SWr). Therefore, in response to the detection of one of the positive electrode event and the negative electrode event, the above-described reference level Lref is reset, and the event detection circuit 33 is reset to a state where a new event can be detected.

Note that, at least a time length equal to or longer than a time length required for the positive-electrode-side output voltage Vop and the negative-electrode-side output voltage Vom after the change to be retained in the positive-electrode-side memory 37p and the negative-electrode-side memory 37m when the positive-electrode-side output voltage Vop and the negative-electrode-side output voltage Vom change to the H level or the L level is only required to set as a delay time length of the delayer 40. Therefore, it is possible to prevent detection omission of an event.

Note that, in a case where the event image is obtained in a predetermined frame cycle as in the present example, it is also conceivable to configure such that the event detection circuit 33 is reset by the reset signal RST in the frame cycle.

As described above, the event image generation section 20 is configured to generate an event image indicating, for every event pixel 20g (that is, for every coordinates of the pixel unit Gu), the presence or absence of the occurrence of the event as the positive electrode event or the negative electrode event, in a predetermined frame cycle. For example, the event image can be generated in a frame cycle by collecting, for every frame period, event data to which detection time information indicating a time within the frame period is attached.

### 1-2. Sensor Section as First Embodiment

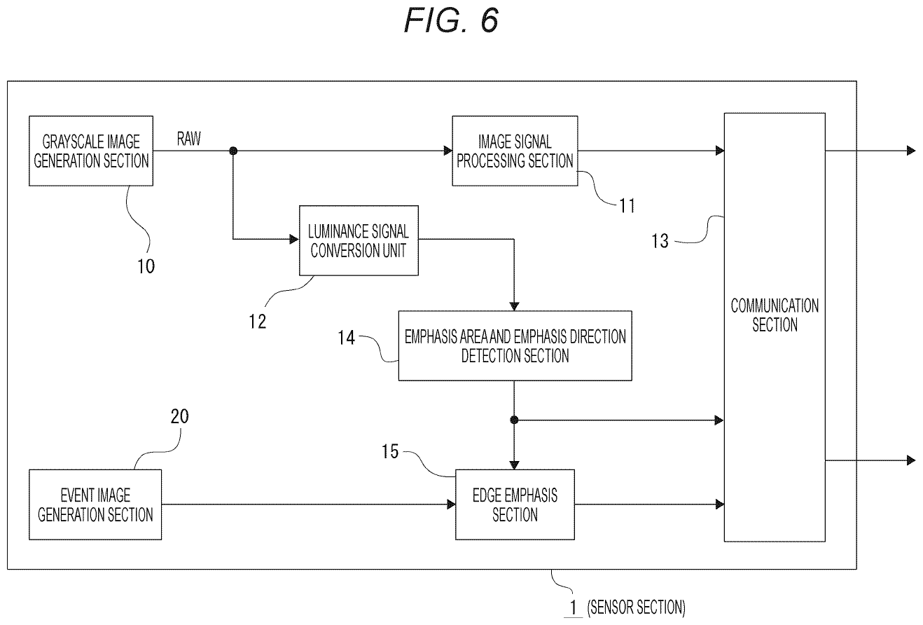

FIG. 6 is a diagram illustrating an internal configuration example of the sensor section 1 as the first embodiment.

The sensor section 1 is an embodiment of the signal processing device and a sensor device according to the present technology.

As illustrated in the drawing, the sensor section 1 includes an image signal processing section 11, a luminance signal conversion section 12, a communication section 13, an emphasis area and emphasis direction detection section 14, and an edge emphasis section 15 together with the grayscale image generation section 10 and the event image generation section 20 illustrated in FIG. 1 above.

The sensor section 1 is constituted as one semiconductor package by stacking a semiconductor substrate on which the pixel array section 1a including the grayscale pixel group in the grayscale image generation section 10 and the event pixel group in the event image generation section 20 are formed and one or a plurality of semiconductor substrates on which other circuit sections other than the pixel array section 1a are formed.

As illustrated in the drawing, the grayscale image by the RAW image obtained by the grayscale image generation section 10 is input to the image signal processing section 11. The image signal processing section 11 performs demosaic processing on the grayscale image by the input RAW image to generate an RGB color image. The demosaic processing mentioned here means processing of calculating a luminance value of each color of R, G, and B for every pixel position (including a pixel position of the event pixel 20g) of the pixel array section 1a.

The communication section 13 performs data communication conforming to a predetermined data communication format with an external device of the sensor section 1, specifically, the image use processing section 2 illustrated in FIG. 1 in the present example.

The grayscale image in an RGB color image format by the image signal processing section 11 is output as an input image of the image use processing section 2 via the communication section 13.

The event image generated by the event image generation section 20 is input to the edge emphasis section 15.

The edge emphasis section 15 performs edge emphasis processing on the event image input from the event image generation section 20. Specifically, the edge emphasis section 15 performs the edge emphasis processing of the event image on the basis of an edge direction of the subject detected on the basis of the grayscale image generated by the grayscale image generation section 10.

In the present example, the emphasis area and emphasis direction detection section 14 detects the edge direction of the subject based on the grayscale image on the basis of a luminance signal image generated by the luminance signal conversion section 12.

The luminance signal conversion section 12 generates a luminance signal image (monochrome image) by adding the luminance values of R, G, and B at a predetermined ratio for every pixel unit Gu to the grayscale image generated by the grayscale image generation section 10.

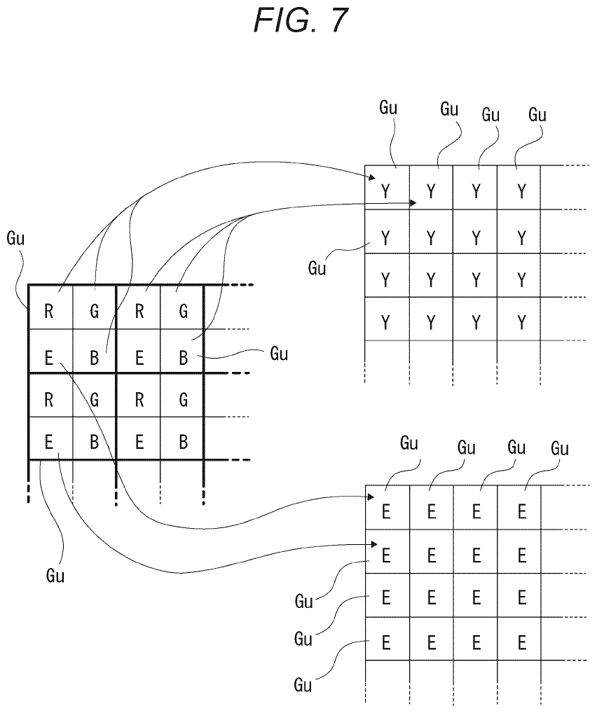

FIG. 7 illustrates comparison between the luminance signal image obtained by the luminance signal conversion section 12 and the event image generated by the event image generation section 20.

As illustrated in the drawing, the luminance signal image (upper right image in the drawing) is generated as an image indicating a value (“Y”) of the luminance signal for every coordinates of the pixel unit Gu.

Furthermore, an event image (lower right image in the drawing) is generated as an image indicating the presence or absence of the occurrence (presence or absence of the detection) of the event for every coordinates of the pixel unit Gu.

A configuration in which the luminance signal conversion section 12 described above is provided and the emphasis area and emphasis direction detection section 14 performs edge detection on the basis of the luminance signal image is adopted, and thus, it is possible to reduce the amount of data treated in processing of the edge detection and reduce a processing load related to the edge detection as compared with a case where the edge detection is performed on the basis of the demosaiced image.

In FIG. 6, the emphasis area and emphasis direction detection section 14 performs the edge detection processing of the subject on the basis of the luminance signal image generated by the luminance signal conversion section 12, and performs processing of setting an edge emphasis unit area and an edge emphasis direction for every edge emphasis unit area on the basis of an edge detection result.

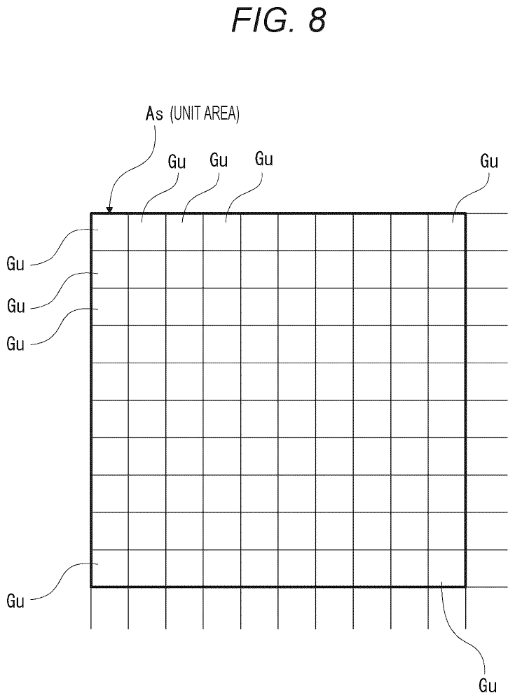

FIG. 8 is an explanatory diagram of a unit area As in each of the luminance signal image and the event image.

First, as a premise, in the luminance signal image and the event image of the present example, a region corresponding to one pixel unit Gu is one pixel on the image.

As illustrated in the drawing, the unit area As means an area including a plurality of predetermined pixels in each of the luminance signal image and the event image. In the present example, the unit area As is defined as an area in which both the number of pixels in the horizontal direction and the number of pixels in the vertical direction are plural. In the drawing, for the sake of convenience in illustration, although it has been illustrated that the unit area As is an area where the number of pixels in the horizontal direction x the number of pixels in the vertical direction=10×10=100 pixels, the number of pixels of the unit area As is not limited thereto. As an example, the unit area As is, for example, an area where the numbers of pixels of the luminance signal image and the event image are 240×240=57600 pixels and the number of pixels in the horizontal direction×the number of pixels in the vertical direction=30×30=900 pixels. In this case, the luminance signal image and the event image are divided by 8×8=64 unit areas As.

In FIG. 6, the emphasis area and emphasis direction detection section 14 performs the edge detection processing on the luminance signal image for every unit area As, and sets the unit area As in which the edge is detected as the edge emphasis unit area as the unit area As to be subjected to the edge emphasis processing.

Moreover, the emphasis area and emphasis direction detection section 14 sets, as the edge emphasis direction, a direction in which the detected edge faces for the edge emphasis unit area.

The edge emphasis section 15 performs the edge emphasis processing on the event image input from the event image generation section 20 on the basis of information indicating the edge emphasis unit area and information of the edge emphasis direction set for every edge emphasis unit area from the emphasis area and emphasis direction detection section 14. Specifically, among the unit areas As in the event image, only the unit area As corresponding to the edge emphasis unit area is subjected to the edge emphasis processing according to the set edge emphasis direction.

The event image subjected to the edge emphasis processing by the edge emphasis section 15 is output to the communication section 13.

Furthermore, the information indicating the edge emphasis unit area obtained by the emphasis area and emphasis direction detection section 14 and the information indicating the edge emphasis direction set for every edge emphasis unit area are also input to the communication section 13.

The communication section 13 outputs the event image subjected to the edge emphasis processing to the image use processing section 2 in a data format conforming to a predetermined data communication format. At this time, the communication section 13 of the present example performs processing of outputting, as metadata of the event image, edge-emphasis-related information based on the information input from the emphasis area and emphasis direction detection section 14, that is, the information indicating the edge emphasis unit area, and the information of the edge emphasis direction set for every edge emphasis unit area, and the details thereof will be described later again.

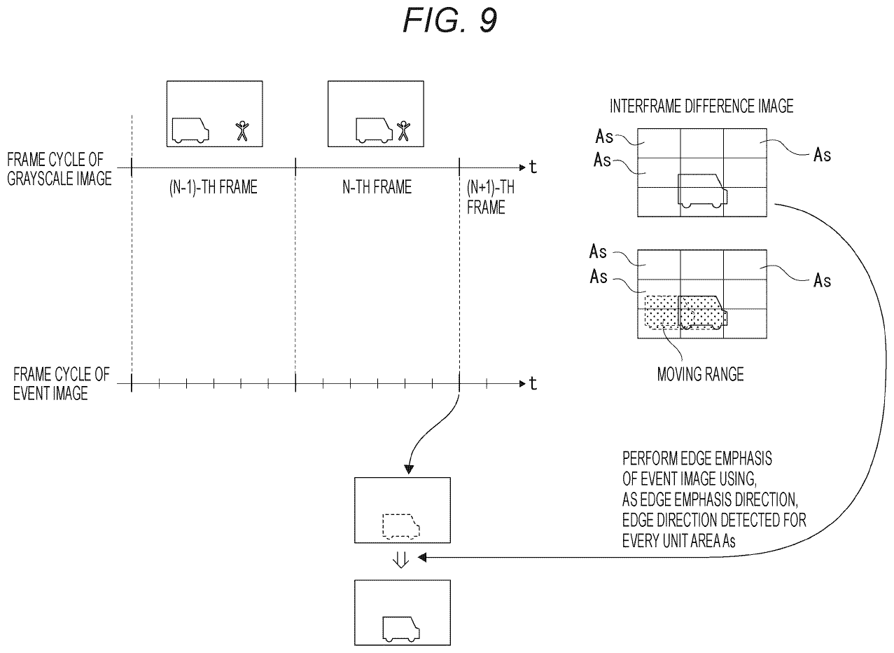

A specific example of an edge emphasis method as the first embodiment will be described with reference to FIGS. 9 to 11.

FIG. 9 is a diagram for explaining an outline of the edge emphasis method as the first embodiment.

In the drawing, a relationship between the frame cycle of the grayscale image (that is, the frame cycle of the luminance signal image) and the frame cycle of the event image is illustrated. As described above, the frame cycle of the event image is shorter than the frame cycle of the grayscale image.

In the present example, the detection of the edge direction based on the grayscale image is performed on an interframe difference image of the luminance signal image. In the drawing, interframe difference images of luminance signal images of an (N−1)-th frame and an N-th frame of the grayscale image are illustrated, but since only the subject as a moving body is detected in the interframe difference image, in the example in the drawing, of a subject (moving object) as a vehicle and a subject (non-moving object) as a human captured in the luminance signal image, only the subject as the vehicle is detected.

In the drawing, a moving range in the image from the (N−1)-th frame to the N-th frame of the subject of the vehicle as the moving object is schematically illustrated below the interframe difference image.

The emphasis area and emphasis direction detection section 14 in the present example generates the interframe difference image of the luminance signal image described above, performs edge detection for every unit area As on the interframe difference image, and sets the edge emphasis unit area and sets the edge emphasis direction for every edge emphasis unit area on the basis of an edge detection result for every unit area As.

Then, the edge emphasis section 15 performs the edge emphasis processing on the event image according to the pieces of information of the edge emphasis unit area and the edge emphasis direction set as described above. In this case, since the pieces of information of the edge emphasis unit area and the edge emphasis direction are obtained after the grayscale image (luminance signal image) of the N-th frame is obtained, the edge emphasis processing is performed on each event image generated during a frame period of a (N+1)-th frame.

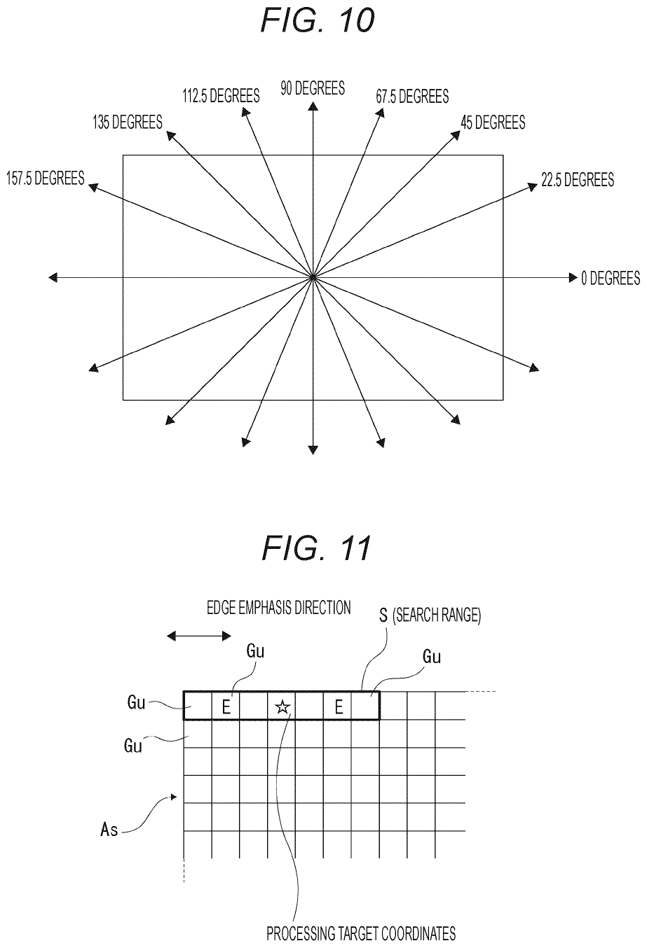

FIG. 10 is an explanatory diagram of the edge emphasis direction determined for every edge emphasis unit area.

As illustrated in the drawing, in the present example, eight directions are defined as the edge emphasis direction. Specifically, when the horizontal direction of the luminance signal image and the event image is 0 degrees, eight directions up to 157.5 degrees are defined in increments of 22.5 degrees.

Note that, setting the number of edge emphasis directions to eight is merely an example, and the number of edge emphasis directions can be voluntarily defined.

In the setting of the edge emphasis direction for every edge emphasis unit area, the emphasis area and emphasis direction detection section 14 in the present example sets, as the edge emphasis direction, one of the eight directions in accordance with the direction in which the detected edge faces. At this time, in a case where edges in a plurality of directions are detected, it is conceivable to set a direction of a dominant edge (for example, a longest edge) among the edges as the edge emphasis direction. Alternatively, it is also conceivable to set a direction having the largest number of edges as the edge emphasis direction when each detected edge is classified for each direction.

In any case, the edge direction dominant in the edge emphasis unit area is only required to set as the edge emphasis direction in the setting of the edge emphasis direction for every edge emphasis unit area.

FIG. 11 is an explanatory diagram of an example of the edge emphasis processing according to the embodiment.

In the present example, in a case where two event detection pixels are present separately from each other via an event non-detection pixel in the edge direction (edge emphasis direction) detected on the basis of the grayscale image, the edge emphasis processing is performed by replacing the event non-detection pixel with an event detection pixel.

Specifically, in the edge emphasis processing of the present example, first, a search range S for edge emphasis is determined in the unit area As as the edge emphasis unit area. The search range S is determined as a range of a plurality of pixels disposed side by side in the edge emphasis direction. In the drawing, an example in which a range of seven pixels disposed side by side in the horizontal direction is determined as the search range S in correspondence with a case where the edge emphasis direction set for the edge emphasis unit area to be processed is a direction of 0 degrees is illustrated.

The search range S is determined as a range with a pixel to be processed (processing target coordinates) as a center.

The edge emphasis processing in this case is executed while shifting the pixels to be processed (processing target coordinates) one by one within the edge emphasis unit area of the event image. Specifically, first, it is determined whether or not the processing target coordinates are event non-detection coordinates in which the event is not detected. When the processing target coordinates are the event non-detection coordinates, it is determined whether or not the processing target coordinates are sandwiched between two event detection coordinates (represented by “E” in the drawing) within the search range S with the processing target coordinates as the center. Then, when the processing target coordinates are sandwiched between the two event detection coordinates, processing of setting the event non-detection coordinates as the processing target coordinates to the event detection coordinates is performed.

The edge emphasis section 15 of the present example executes the above-described processing for every edge emphasis unit area. Therefore, the edge emphasis of the event image can be realized.

Here, in a case where the positive electrode event and the negative electrode event are separately detected as the events as in the present example, it is conceivable to individually perform the edge emphasis of the event image for each of an edge of the positive electrode event and an edge of the negative electrode event.

In the edge emphasis processing in this case, as processing for every processing target coordinates, it is conceivable to determine whether or not the processing target coordinates are in a state where one of a condition in which the processing target coordinates are sandwiched between two positive electrode event detection coordinates or a condition in which the processing target coordinates are sandwiched between two negative electrode event detection coordinates is satisfied in the search range S, set the processing target coordinates as the event non-detection coordinates to the positive electrode event detection coordinates in a case where the former condition is satisfied, and set the processing target coordinates as the event non-detection coordinates to the negative electrode event detection coordinates in a case where the latter condition is satisfied.

### 1-3. Processing Procedure

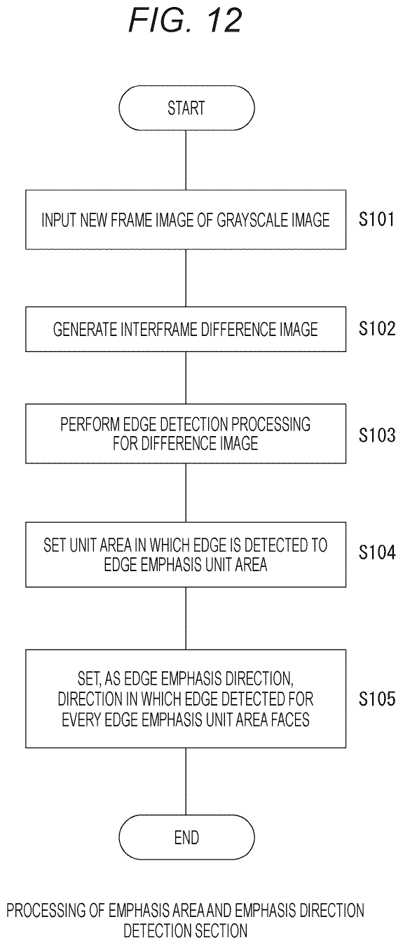

FIG. 12 is a flowchart illustrating an example of a specific processing procedure executed by the emphasis area and emphasis direction detection section 14.

In step S101, the emphasis area and emphasis direction detection section 14 inputs a new frame image of the grayscale image. That is, in the present example, a frame image of a luminance signal image newly generated by the luminance signal conversion section 12 is input.

In step S102 subsequent to step S101, the emphasis area and emphasis direction detection section 14 generates an interframe difference image, that is, an interframe difference image of the luminance signal image, and further performs the edge detection processing on the difference image (interframe difference image) in subsequent step S103.

In step S104 subsequent to step S103, the emphasis area and emphasis direction detection section 14 performs processing of setting the unit area in which the edge is detected as the edge emphasis unit area.

Then, in step S105 subsequent to step S104, the emphasis area and emphasis direction detection section 14 performs processing of setting the direction in which the detected edge faces as the edge emphasis direction for every edge emphasis unit area, and terminates the series of processing illustrated in FIG. 12.

Note that, details of the processing of setting the edge emphasis direction for every edge emphasis unit area have already been described, and thus, redundant description is avoided.

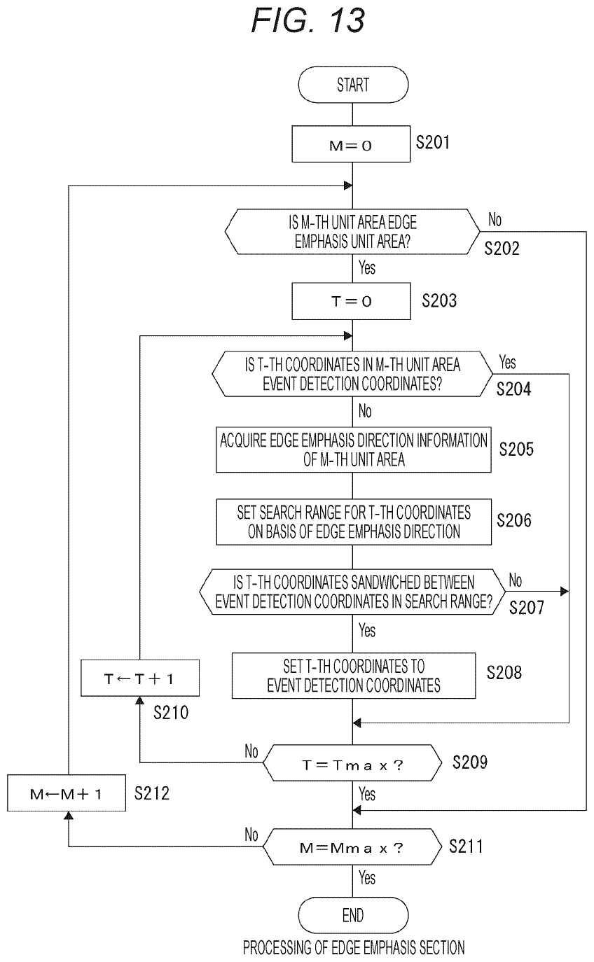

FIG. 13 is a flowchart illustrating an example of a specific processing procedure executed by the edge emphasis section 15.

In step S201, the edge emphasis section 15 performs processing of resetting a unit area identifier M to 0, and in subsequent step S202, it is determined whether or not an M-th unit area As is the edge emphasis unit area. This determination processing can be performed on the basis of the information indicating the edge emphasis unit area input from the emphasis area and emphasis direction detection section 14.

In a case where it is determined in step S202 that the M-th unit area As is the edge emphasis unit area, the edge emphasis section 15 proceeds to step S203, resets a pixel coordinate identifier T to 0, and then determines in step S204 whether or not T-th coordinates in the M-th unit area As are the event detection coordinates.

In a case where it is determined in step S204 that the T-th coordinates in the M-th unit area As are not the event detection coordinates (that is, the event non-detection coordinates), the edge emphasis section 15 proceeds to step S205, acquires the edge emphasis direction information of the M-th unit area, and then sets the search range S for the T-th coordinates on the basis of the edge emphasis direction in subsequent step S206.

Then, in step S207 subsequent to step S206, the edge emphasis section 15 determines whether or not the T-th coordinates are sandwiched between the event detection coordinates in the search range S. When the T-th coordinates are sandwiched between the event detection coordinates, the edge emphasis section proceeds to step S208, sets the T-th coordinates to the event detection coordinates, and then proceeds to step S209.

In step S209, the edge emphasis section 15 determines whether or not the pixel coordinate identifier T reaches an upper limit value Tmax. Here, the upper limit value Tmax means a total number of pixels in the unit area As (edge emphasis unit area) to be processed, and step S209 corresponds to processing of determining whether or not the processing is executed for all the pixels in the edge emphasis unit area to be processed.

In step S209, when the pixel coordinate identifier T does not reach the upper limit value Tmax, the edge emphasis section 15 increments the pixel coordinate identifier T by 1 in step S210, and then returns to step S204 described above. Therefore, the processing of steps S204 to S208 can be executed for the new pixel.

Here, in a case where it is determined in step S204 that the T-th coordinates in the M-th unit area As are the event detection coordinates, the edge emphasis section 15 proceeds to step S209. That is, in a case where the processing target coordinates are the event detection coordinates, the processing of setting the processing target coordinates to the event detection coordinates is unnecessary, and thus, the processing of steps S205 to S208 is skipped.

Furthermore, in a case where it is determined in step S207 that the T-th coordinates are not sandwiched between the event detection coordinates in the search range S, the edge emphasis section 15 proceeds to step S209. That is, in a case where the T-th coordinates are not sandwiched between the event detection coordinates in the search range S, the processing of setting the processing target coordinates as the event non-detection coordinates to the event detection coordinates is not performed.

In a case where it is determined in step S209 that the pixel coordinate identifier T reaches the upper limit value Tmax, the edge emphasis section 15 proceeds to step S211, and determines whether or not the unit area identifier M reaches an upper limit value Mmax. Here, the upper limit value Mmax means a total number of unit areas As when the event image is divided into the unit areas As as division units, and step S211 corresponds to processing of determining whether or not the processing is executed for all the unit areas As.

In a case where it is determined in step S211 that the unit area identifier M does not reach the upper limit value Mmax, the edge emphasis section 15 increments the unit area identifier M by 1 in step S212, and then returns to previous step S202. Therefore, the processing for the next unit area As is started in response to the completion of the processing for one unit area As.

Specifically, in a case where it is determined in step S202 that the M-th unit area As is the edge emphasis unit area, the processing in and after step S203 is executed for edge emphasis.

On the other hand, in a case where it is determined in step S202 that the M-th unit area As is not the edge emphasis unit area, the edge emphasis section 15 proceeds to step S211 described above. Therefore, the processing for edge emphasis is not performed for the unit area As other than the edge emphasis unit area.

Accordingly, since the edge emphasis of the event image is not unnecessarily performed up to the unit area As in which the edge is not detected on the grayscale image (luminance signal image) side, the accuracy of the edge emphasis processing for the event image can be improved. Furthermore, since the edge emphasis processing for the unit area As for which the edge emphasis processing is unnecessary is omitted, a processing load can be reduced.

In a case where it is determined in step S211 that the unit area identifier M reaches the upper limit value Mmax, the edge emphasis section 15 terminates the series of processing illustrated in FIG. 13.

Note that, as described above, in a case where the positive electrode event and the negative electrode event are separately detected as the events, the edge emphasis of the event image can be performed individually for each of the edge of the positive electrode event and the edge of the negative electrode event. Since a specific example of the edge emphasis processing in that case has already been described, redundant description is avoided.

### 1-4. About Edge Emphasis-Related Information

As described above, the communication section 13 (see FIG. 6) in the present example performs processing of outputting the edge emphasis-related information as the metadata of the event image.

The edge emphasis-related information as the metadata is only is only required to be stored in a predetermined data region in predetermined output unit data such as packet data, for example, when the communication section 13 transmits the event image according to a predetermined data communication format.

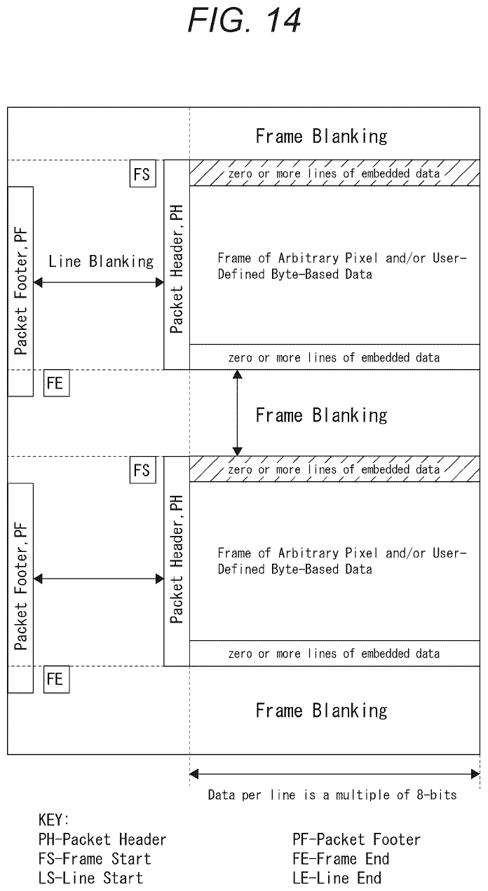

FIGS. 14 to 16 are diagrams for explaining a storage example of the edge emphasis-related information as the metadata. Specifically, here, a storage example of edge emphasis-related information corresponding to a case where the communication section 13 performs data communication according to a mobile industry processor interface (MIPI) format will be described.

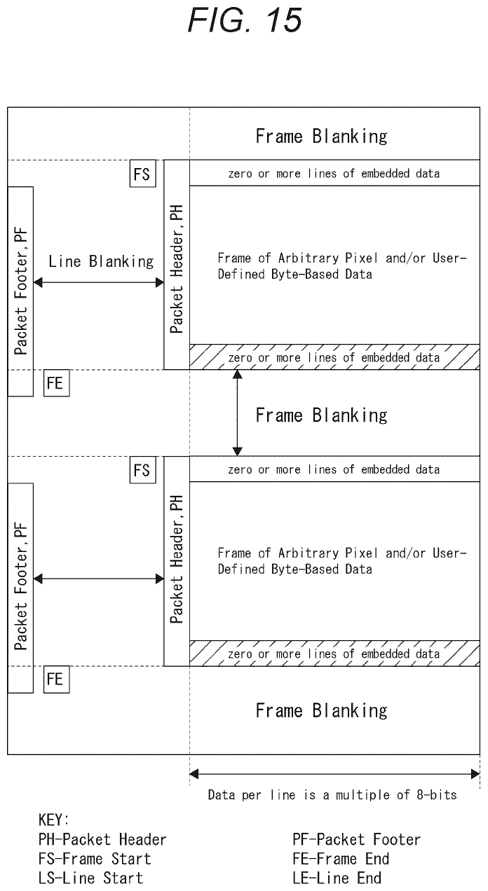

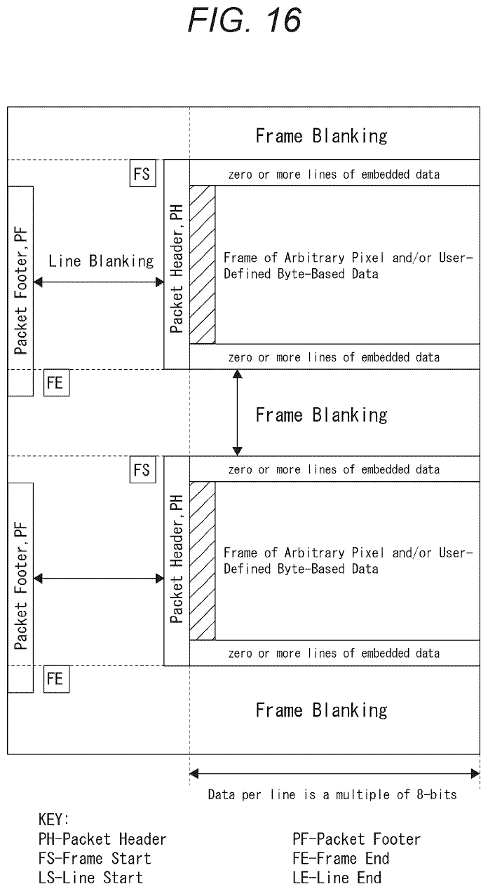

FIG. 14 illustrates an example in which the edge emphasis-related information is stored in an Embedded Data (EMB) region at a frame head defined in packet data in an MIPI format, and FIG. 15 illustrates an example in which the edge emphasis-related information is stored in the Embedded Data region at a frame end defined in the packet data. Furthermore, FIG. 16 illustrates an example in which the edge emphasis-related information is stored at the head of each line defined in the packet data.

Here, in a case where the Embedded Data region at the frame head is targeted as illustrated in FIG. 14, for example, it is conceivable to store, as the edge emphasis-related information, coordinate information of the edge emphasis unit area or information indicating which unit area is the edge emphasis unit area. These pieces of information can be generated by the communication section 13 on the basis of the information indicating the edge emphasis unit area input from the emphasis area and emphasis direction detection section 14.

Furthermore, as the edge emphasis-related information in this case, it is also conceivable to store information (for example, a frame number, a time stamp, or the like) indicating a grayscale image that is a detection source of the edge emphasis direction.

For example, these pieces of edge emphasis-related information are stored at the frame head. Thus, in the image use processing section 2, in the image analysis processing using the event image of the corresponding frame as the input image, for example, it is possible to perform response processing such as selecting a method of image processing on the basis of an evaluation result of image reliability according to the presence or absence of the edge emphasis, and it is possible to improve the accuracy of the image analysis processing using the event image as the input image.

Furthermore, in a case where the Embedded Data region at the frame end is targeted as illustrated in FIG. 15, for example, information indicating the presence or absence of the edge emphasis of each unit area As can be stored as the edge emphasis-related information. The information indicating the presence or absence of the edge emphasis of each unit area As is information indicating whether or not the edge emphasis processing is actually performed by the edge emphasis section 15.

When the information indicating whether or not the edge emphasis is actually performed is stored in the EMB region at the frame head, the output is delayed by one frame. Data is stored in a last EMB region at the frame end, and thus, it is possible to prevent the output from being delayed by one frame as described above. As a result, it is advantageous in terms of a real-time property of the image analysis processing in a subsequent stage.

In a case where the head of the line is targeted as illustrated in FIG. 16, it is conceivable to store, as the edge emphasis-related information, information indicating the presence or absence of the edge emphasis unit area in the line and information indicating the presence or absence of the edge emphasis of each unit area As in the line.

Therefore, in a case where only a region of interest (ROI) in the input image is used for processing on the image use processing section 2 side, a line without an edge emphasis unit area or a line having no unit area with edge emphasis can be excluded from a processing target, and a calculation load of the image analysis processing in the subsequent stage can be reduced.

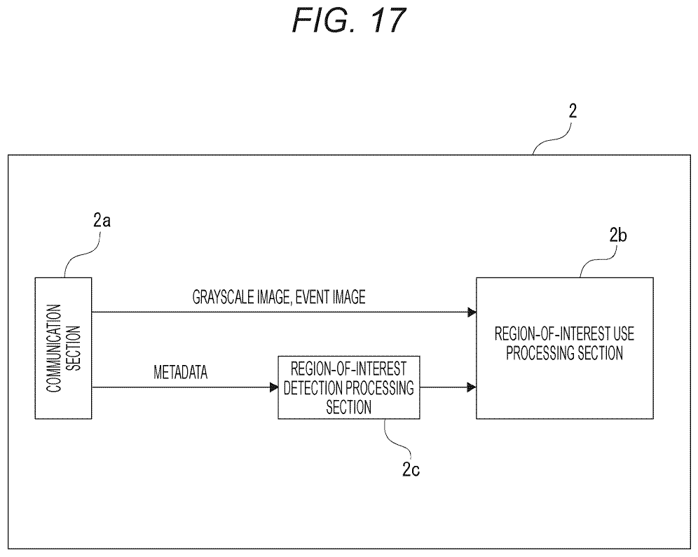

A configuration example and an operation example of the image use processing section 2 in a case where the calculation load is reduced by using the edge emphasis-related information will be described with reference to a block diagram of FIG. 17.

The image use processing section 2 in this case includes a communication section 2a, a region-of-interest use processing section 2b, and a region-of-interest detection processing section 2c as illustrated in the drawing.

The communication section 2a receives the demosaiced grayscale image output from the communication section 3 and the packet data of the event image that is also output from the communication section 3 and in which the edge emphasis-related information is stored as the metadata. The communication section 2a extracts the event image and the metadata as the edge emphasis-related information from the packet data, outputs the demosaiced grayscale image and the event image to the region-of-interest use processing section 2b, and outputs the metadata (edge emphasis-related information) to the region-of-interest detection processing section 2c.

The region-of-interest detection processing section 2c detects a region of interest in the grayscale image or the event image on the basis of the input edge emphasis-related information. Specifically, for each of the grayscale image and the event image, an image area corresponding to the edge emphasis unit area is detected as the region of interest.

The region-of-interest use processing section 2b performs image analysis processing on the region of interest detected by the region-of-interest detection processing section 2c.

Here, examples of the image analysis processing in this case include monitoring processing or face recognition processing for a specific subject such as a human or a vehicle, simultaneous localization and mapping (SLAM) processing, eye tracking processing, and hand tracking processing.

### 2. Second Embodiment

Next, a second embodiment will be described.

In the second embodiment, edge emphasis is performed between the grayscale image side and the event image side.

Note that, in the following description, the same reference signs are given to portions similar to those already described, and description thereof is omitted.

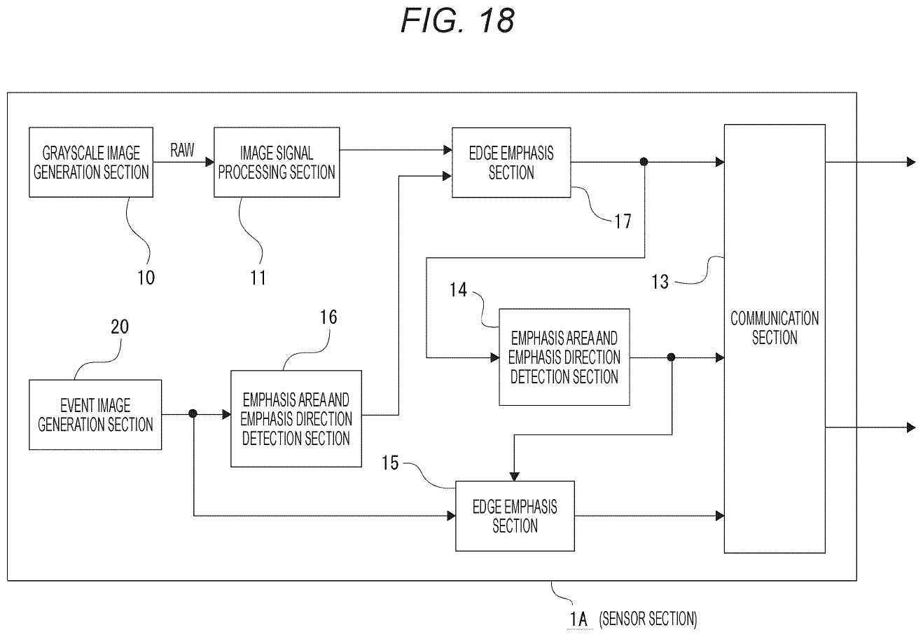

FIG. 18 is a block diagram illustrating an internal configuration example of a sensor section 1A as a second embodiment.

In the second embodiment, a configuration of the imaging device 100 is similar to that of the first embodiment except that the sensor section 1A is provided instead of the sensor section 1, and thus, the description thereof will be omitted.

As can be seen from comparison with FIG. 6 described above, the sensor section 1A is different from the sensor section 1 in that the luminance signal conversion section 12 is omitted and that an emphasis area and emphasis direction detection section 16 and an edge emphasis section 17 are added.

The emphasis area and emphasis direction detection section 16 detects the edge direction of the subject on the basis of the event image input from the event image generation section 20. In the present example, the emphasis area and emphasis direction detection section 16 also sets the edge emphasis unit area and sets the edge emphasis direction for every edge emphasis unit area on the basis of a result of performing the edge detection for every unit area As by a method similar to that of the emphasis area and emphasis direction detection section 14.

Here, since the event image can be regarded as an image in which the subject as the moving object is detected, there is no need to generate the interframe image as in the case of the grayscale image. From this point, the emphasis area and emphasis direction detection section 16 performs edge detection for every unit area As on an event image for one frame, and sets an edge emphasis unit area and an edge emphasis direction for every edge emphasis unit area on the basis of the result.

The edge emphasis section 17 performs the edge emphasis processing based on information indicating an edge emphasis unit area obtained by the emphasis area and emphasis direction detection section 16 and information indicating an edge emphasis direction for every edge emphasis unit area, on the grayscale image (RGB color image) subjected to the demosaic processing by the image signal processing section 11. That is, the edge emphasis section 17 performs the edge emphasis processing on the demosaiced grayscale image on the basis of the edge direction of the subject detected on the basis of the event image.

Here, the edge emphasis section 17 performs the edge emphasis processing according to the information indicating the edge emphasis direction for every image area corresponding to the edge emphasis unit area set by the emphasis area and emphasis direction detection section 16 for the demosaiced grayscale image.

As illustrated in the drawing, in the sensor section 1A, the demosaiced grayscale image edge-emphasized by the edge emphasis section 17 is input to the communication section 13 and is output to the image use processing section 2.

In this case, the emphasis area and emphasis direction detection section 14 detects the edge direction on the basis of the grayscale image subjected to the edge emphasis processing by the edge emphasis section 17. Specifically, for the grayscale image subjected to the edge emphasis processing by the edge emphasis section 17, the interframe difference image is generated, the edge detection is performed for every image area corresponding to the unit area As in the interframe difference image, and the setting of the edge emphasis unit area and the setting of the edge emphasis direction for every edge emphasis unit area are performed on the basis of the result.

In this case, the edge emphasis section 15 also performs the edge emphasis processing on the event image generated by the event image generation section 20 according to the information indicating the edge emphasis unit area set by the emphasis area and emphasis direction detection section 14 and the information indicating the edge emphasis direction for every edge emphasis unit area by a method similar to that in the first embodiment.

The edge emphasis section 15 in this case performs the edge emphasis processing on the event image on the basis of the edge direction detected on the basis of the image after the edge emphasis by the edge emphasis section 17 that performs edge emphasis on the grayscale image.

Therefore, mutual edge interpolation between the event image side and the grayscale image side is realized, and the accuracy of the edge emphasis processing of the event image can be further improved.

Here, in the above example, the edge emphasis section 17 performs the edge emphasis of the grayscale image on the basis of the edge direction detected on the basis of the event image on which the edge emphasis is not performed. However, it is also conceivable that the edge emphasis section 17 performs the edge emphasis of the grayscale image on the basis of the edge direction detected on the basis of the event image after the edge emphasis.

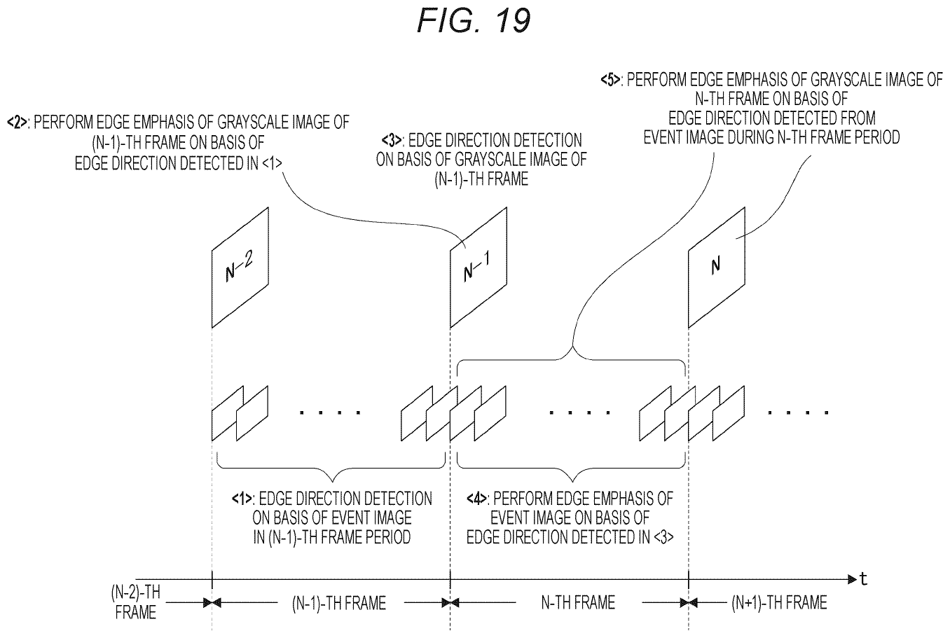

FIG. 19 is a diagram for explaining an operation example in a case where the edge emphasis section 17 performs the edge emphasis of the grayscale image on the basis of the edge direction detected on the basis of the event image after the edge emphasis as described above.

First, as indicated by <1> in the drawing, it is assumed that edge direction detection based on the event image is performed during a frame period of an (N−1)-th frame. As understood from the above description, the edge direction detection based on the event image is performed by the emphasis area and emphasis direction detection section 16.

In a case where the edge emphasis section 17 performs the edge emphasis of the grayscale image on the basis of the edge direction detected on the basis of the event image after the edge emphasis, the emphasis area and emphasis direction detection section 16 is configured to receive, as an input, the event image after the edge emphasis processing by the edge emphasis section 15.

Next, as indicated by <2>, the edge emphasis of the grayscale image (demosaiced grayscale image) of the (N−1)-th frame is performed on the basis of the edge direction detected in <1> (edge emphasis section 17).

Then, as indicated by <3>, edge direction detection based on the grayscale image of the (N−1)-th frame after the edge emphasis is performed (emphasis area and emphasis direction detection section 16).

Moreover, as indicated by <4>, the edge emphasis of the event image obtained during a frame period of the N-th frame is performed on the basis of the edge direction detected in <3> (edge emphasis section 15).

Moreover, as indicated by <5>, the edge emphasis of the grayscale image of the N-th frame is performed on the basis of the edge direction detected from the event image during the frame period of the N-th frame (edge emphasis section 17).

As described above, as mutual edge interpolation between the event image side and the grayscale image side, it is also conceivable that the edge emphasis section 17 performs the edge emphasis of the grayscale image on the basis of the edge direction detected on the basis of the event image after the edge emphasis. In this case, it is also possible to further improve the accuracy of the edge emphasis processing of the event image.

Note that, in the above description, as the edge emphasis processing on the grayscale image side, an example in which the edge emphasis processing on the demosaiced grayscale image is performed has been described. However, in a case where the luminance signal conversion section 12 is provided as in the first embodiment, and in a case where a configuration in which the luminance signal image is output as the input image of the image use processing section 2 is adopted, it is also conceivable to perform the edge emphasis processing on the luminance signal image generated by the luminance signal conversion section 12. In this case, similarly to the first embodiment, it is also possible to adopt a configuration in which the emphasis area and emphasis direction detection section 14 performs the edge direction detection on the basis of the luminance signal image generated by the luminance signal conversion section 12.

Furthermore, in a case where the grayscale image obtained by the grayscale pixel group is a monochrome image, since it is not necessary to perform the demosaic processing, it is also conceivable to perform the edge emphasis processing based on the edge direction detected on the basis of the event image on the grayscale image itself obtained by the grayscale pixel group.

### 3. Third Embodiment

In a third embodiment, the edge emphasis processing based on the edge detection result of the subject based on the grayscale image and the edge detection result of the subject based on the event image is performed as the edge emphasis processing of the event image.

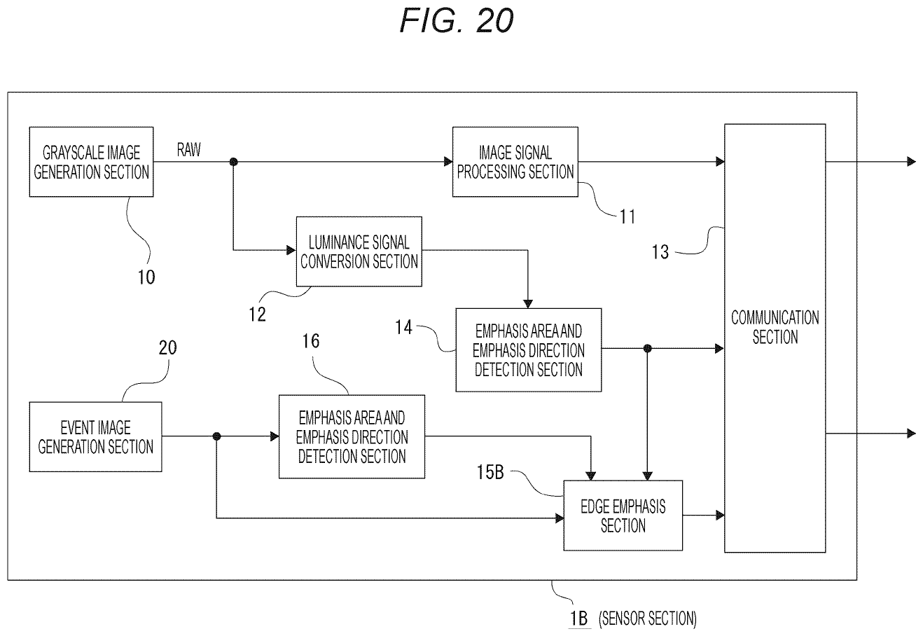

FIG. 20 is a block diagram illustrating an internal configuration example of a sensor section 1B as the third embodiment.

In the third embodiment, a configuration of the imaging device 100 is similar to that of the first embodiment except that the sensor section 1B is provided instead of the sensor section 1, and thus, the description thereof will be omitted.

As can be seen from comparison with FIG. 6 described above, the sensor section 1B is different from the sensor section 1 in that an emphasis area and emphasis direction detection section 16 is added and that an edge emphasis section 15B is provided instead of the edge emphasis section 15.

As described in the second embodiment above, the emphasis area and emphasis direction detection section 16 inputs the event image generated by the event image generation section 20, performs edge detection for every unit area As, and sets the edge emphasis unit area and the edge emphasis direction for every edge emphasis unit area on the basis of a result of the edge detection.

The edge emphasis section 15B performs the edge emphasis processing of the event image on the basis of the edge detection result of the subject based on the grayscale image obtained by the emphasis area and emphasis direction detection section 14 and the edge detection result of the subject based on the event image obtained by the emphasis area and emphasis direction detection section 16.

Specifically, as processing for every unit area As, the edge emphasis section 15B performs edge emphasis processing based on the information of the edge emphasis direction on the unit area As in which the edge is detected by one of the emphasis area and emphasis direction detection sections 14 and 16. In this case, as specific processing, the edge emphasis processing based on the information of the edge emphasis direction is only required to be performed on both the edge emphasis unit area set by the emphasis area and emphasis direction detection section 14 and the edge emphasis unit area set by the emphasis area and emphasis direction detection section 16.

Alternatively, it is also conceivable to perform the edge emphasis processing based on the information of the edge emphasis direction on the unit area As in which the edge is detected by both the emphasis area and emphasis direction detection sections 14 and 16.

Note that, it is also conceivable to set different edge emphasis directions for the same edge emphasis unit area by the emphasis area and emphasis direction detection section 14 and the emphasis area and emphasis direction detection section 16.

In general, the edge detected on the basis of the grayscale image has relatively higher reliability than the edge detected on the basis of the event image between the edge detected on the basis of the event image and the edge detected on the basis of the grayscale image. Thus, in a case where such different edge emphasis directions are set, it is conceivable to adopt the edge emphasis direction by the emphasis area and emphasis direction detection section 14 instead of the edge emphasis direction by the emphasis area and emphasis direction detection section 16 having lower reliability.

### 4. Modifications

Note that, the specific examples described so far are merely examples, and the present technology can adopt configurations as various modifications.

For example, in the above description, as for the edge direction detection of the subject based on the grayscale image, an example in which the edge direction detection is performed on the interframe difference image of the luminance signal image has been described, but the detection of the edge direction may also be performed on the grayscale image (for example, in the case of the monochrome image) or a binarized image of an image generated on the basis of the grayscale image, such as the demosaiced grayscale image or the luminance signal image.

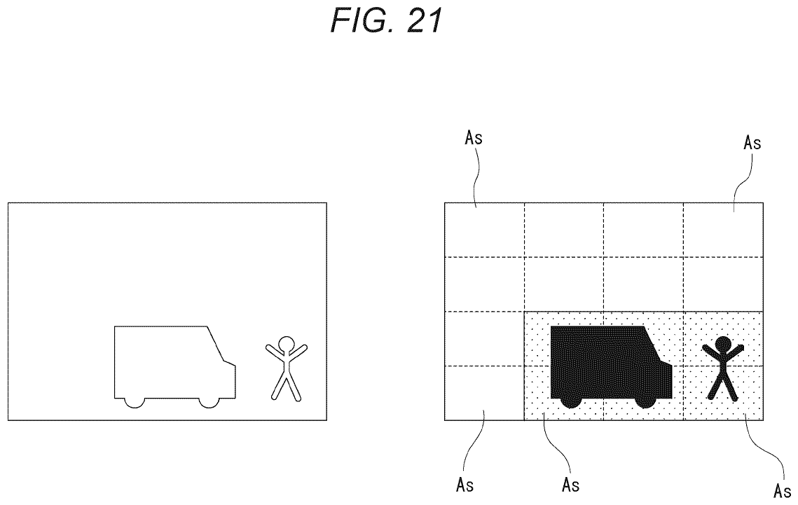

As illustrated in FIG. 21, since the binarized image can be an image in which a subject in a background portion is excluded and only a subject in a foreground portion is extracted, it is suitable in a case where edge emphasis for a subject that can be a moving object moving on a front side of the background is performed, for example.

FIG. 21 illustrates a binarized image obtained by performing binarization processing on the image of the N-th frame illustrated in FIG. 9 (left image in the drawing). In a case where the edge detection is performed on the binarized image to set the edge emphasis unit area, the unit area As indicated by a satin in the drawing is set as the edge emphasis unit area.

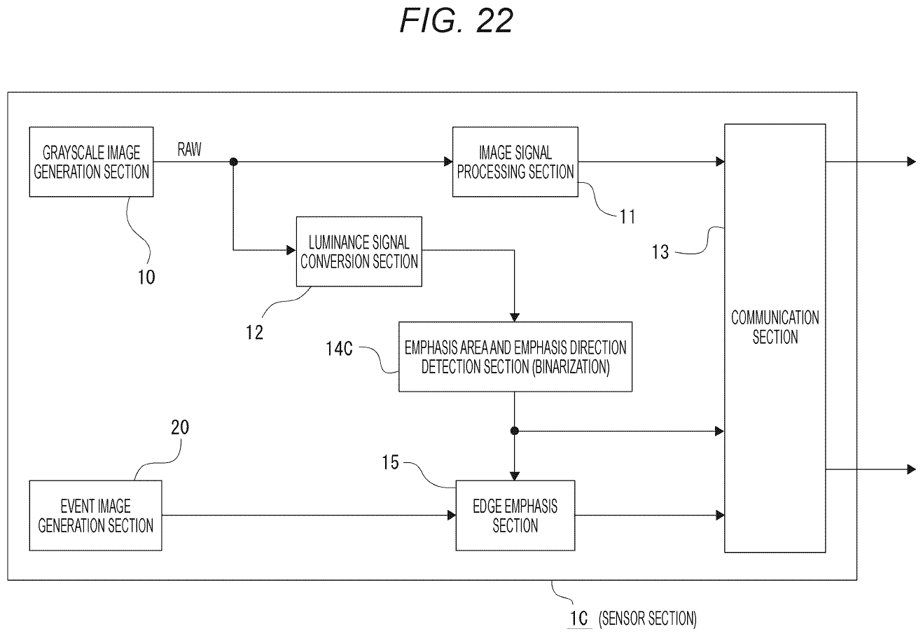

FIG. 22 is a block diagram illustrating an internal configuration example of a sensor section 1C as a modification that performs edge direction detection on such a binarized image.

Here, a configuration example in a case where the edge direction detection is performed on the luminance signal image generated by the luminance signal conversion section 12 is illustrated.

The sensor section 1C is different from the sensor section 1 in that an emphasis area and emphasis direction detection section 14C is provided instead of the emphasis area and emphasis direction detection section 14.

The emphasis area and emphasis direction detection section 14C binarizes the luminance signal image generated by the luminance signal conversion section 12, and performs edge detection for every unit area As, setting of an edge emphasis unit area based on a result of the edge detection, and setting of an edge emphasis direction for every edge emphasis unit area on the binarized image obtained by the binarization.

Note that, in this modification, a configuration that realizes mutual edge interpolation between the event image side and the grayscale image side as in the third embodiment can also be adopted.

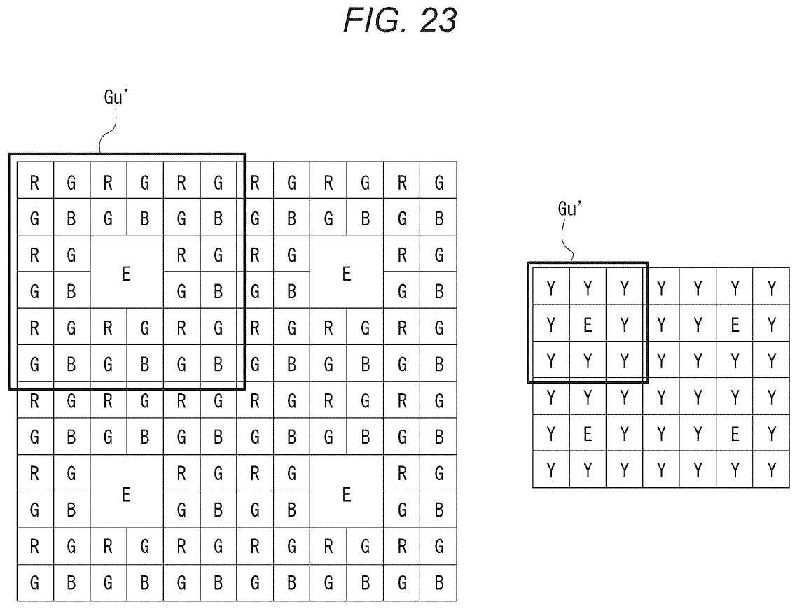

Furthermore, in the above description, as the pixel array pattern in the pixel array section 1a, a pattern in which a plurality of pixel units Gu of 2×2=4 pixels including the grayscale pixels of R, G, and B and the event pixel are two-dimensionally arrayed has been illustrated. However, as illustrated in FIG. 23, as the pixel array pattern in the pixel array section 1a, a pattern in which a plurality of pixel units Gu′ including the grayscale pixels of R, G, and B=32 pixels and the event pixels=1 pixel are two-dimensionally arrayed, or the like can also be adopted.

Specifically, the pixel unit Gu′ in this case is a pixel unit in which three Bayer array pixel units of four pixels by RGGB are arrayed in each of the horizontal direction and the vertical direction and the event pixel of one pixel is arranged in a region having a size of four pixels at a center.

In this case, when luminance signal values are converted in units of Bayer array pixel units in the pixel unit Gu′, as illustrated on a right side in the drawing, in terms of pixel coordinates, coordinates of the central event pixel and pixel coordinates of eight luminance signals present around the event pixel can be treated as the same coordinates.

For example, when the size of the unit area As is a size of 10 pixels×10 pixels, one unit area As is calculated by using Y of (Y pixels) 30 pixels×30 pixels−10 pixels×10 pixels (E pixels)=800 pixels.

Furthermore, in the above description, a case where the configuration as a so-called mixed sensor having the pixel array section 1a in which the grayscale pixel group and the event pixel group are mixed is adopted has been illustrated, but the present technology can also be suitably applied to a case where the grayscale sensor and the event sensor are separated.

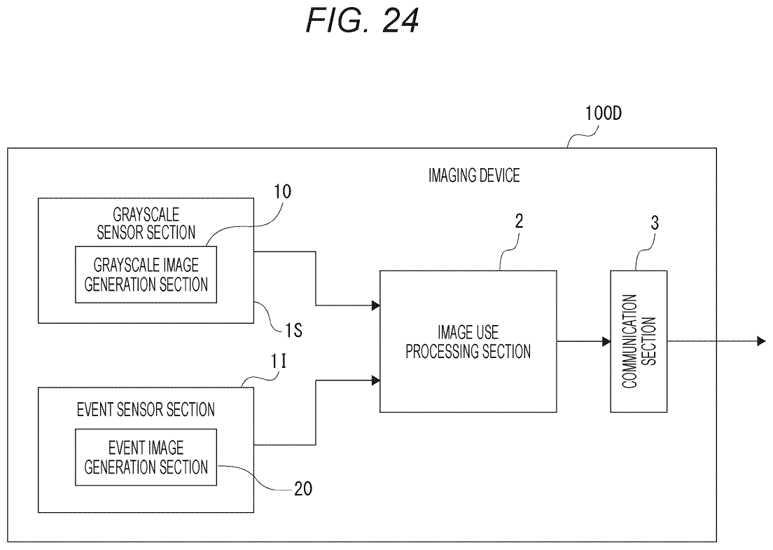

Specifically, as in an imaging device 100D illustrated in FIG. 24, a grayscale sensor section 1S including the grayscale image generation section 10 for obtaining the grayscale image and an event sensor section 1I including the event image generation section 20 for obtaining the event image are separately provided.

Although not illustrated, the grayscale sensor section 1S includes a pixel array section in which the grayscale pixel group is arrayed as the pixel array section, and the grayscale image generation section 10 generates a grayscale image on the basis of grayscale values detected by the grayscale pixel groups in the pixel array section.

Furthermore, the event sensor section 1I includes a pixel array section (referred to as a pixel array section 1a′) in which the event pixel group is arrayed as the pixel array section, and the event image generation section 20 generates an event image on the basis of an event detection result by the event pixel group in the pixel array section 1a′.

Here, in a case where the grayscale sensor section 1S and the event sensor section 1I are separately provided as described above, light from the subject is received in the pixel array section in each sensor via different imaging lenses. Thus, in a case where the edge emphasis processing of the event image on the basis of the edge direction detected on the basis of the grayscale image is performed, coordinate alignment processing is performed between the grayscale image and the event image.

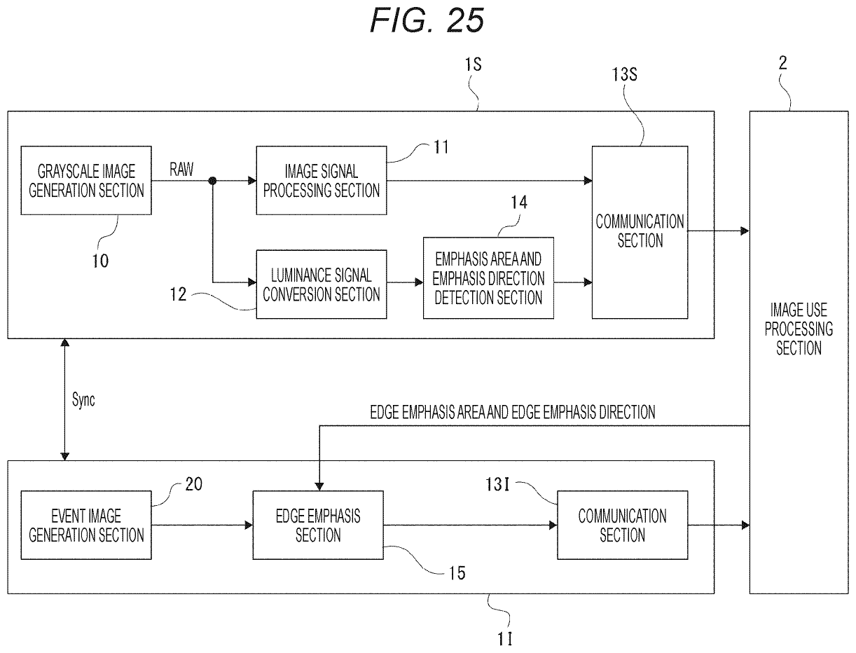

FIG. 25 is a diagram for explaining an internal configuration example of each of the grayscale sensor section 1S and the event sensor section 1I in a case where a configuration of the imaging device 100D illustrated in FIG. 24 is adopted.

In this case, in order to appropriately perform the edge emphasis processing of the event image on the basis of the edge direction detected on the basis of the grayscale image, since it is necessary to synchronize frame cycles between the grayscale sensor section 1S and the event sensor section 1I, as illustrated in the drawing, a synchronization signal Sync is shared between the grayscale sensor section 1S and the event sensor section 1I.

As illustrated in the drawing, the grayscale sensor section 1S includes the image signal processing section 11, the luminance signal conversion section 12, the grayscale area and emphasis direction detection section 14, and a communication section 13S together with the grayscale image generation section 10.

Furthermore, the event sensor section 1I includes the edge emphasis section 15 and a communication section 13I together with the event image generation section 20.

In a case where the grayscale sensor section 1S and the event sensor section 1I are separately provided, it is conceivable that the information indicating the edge emphasis unit area set by the emphasis area and emphasis direction detection section 14 and the information of the edge emphasis direction for every edge emphasis unit area cannot be directly transmitted from the grayscale sensor section 1S to the edge emphasis section 15 in the event sensor section 1I.

In such a case, it is conceivable to output the information indicating the edge emphasis unit area set by the emphasis area and emphasis direction detection section 14 and the information of the edge emphasis direction for every edge emphasis unit area to the image use processing section 2 in a subsequent stage via the communication section 13S and transfer the information to the edge emphasis section 15 by the image use processing section 2.

Note that, in a case where such a configuration is adopted, it is also conceivable to output the metadata as the edge emphasis-related information is output by the communication section 13 S as metadata of the demosaiced grayscale image by the image signal processing section 11 (In particular, in a case where the presence or absence of the edge emphasis unit area and the coordinate information are used as metadata).

In a case where the information related to whether or not the edge emphasis is actually performed is output as the edge emphasis-related information, it is conceivable that the communication section 13I outputs the edge emphasis-related information as the metadata of the event image after the edge emphasis.

Note that, in a case where the grayscale sensor section 1S and the event sensor section 1I are separately provided as in the above modification, the configuration that realizes mutual edge interpolation as described in the second embodiment can also be applied. In this case, it is conceivable to transfer the information of the edge emphasis unit area or the edge emphasis direction detected on the basis of the event image from the event sensor section 1I to the edge emphasis section (the edge emphasis section 17) on the grayscale sensor section 1S side via the image use processing section 2.

Furthermore, in a case where the grayscale sensor section 1S and the event sensor section 1I are separately provided, it is also conceivable that the image use processing section 2 performs edge direction detection based on the grayscale image and outputs the result to the event sensor section 1I.

Furthermore, in the above description, the configuration in which the pixel array section in which the event pixel group is arrayed and the signal processing circuit section including the edge emphasis section 15 are integrally formed has been illustrated, but a configuration in which the pixel array section and the signal processing circuit section are separated is also conceivable. In this case, the signal processing circuit section including the edge emphasis section 15 performs the edge emphasis processing on the event image output from the event sensor including the pixel array section in which the event pixel group is arrayed.

Here, according to the present technology, since the edge of the event image is emphasized (interpolated), it is possible to obtain an appropriate event image in which a missing portion is interpolated even though the number of operating event pixels is thinned out. At this time, the power consumption of the sensor can be reduced by thinning out the number of operating event pixels. Furthermore, since the amount of event data to be treated is also reduced, power consumption of the signal processing section that treats the event data can also be reduced.

### 5. Summary of Embodiments

As described above, the signal processing device (sensor section 1, 1A, 1B, or 1C, or event sensor section 1I) as the embodiment includes the first edge emphasis section (edge emphasis section 15 or 15B) that inputs the event image that is the image indicating the event detection result by the event detection pixel group including the plurality of event pixels that detect, as the event, the change in the amount of light received by the light receiving element by the predetermined amount or more, and performs the edge emphasis processing on the event image on the basis of the edge direction of the subject detected on the basis of the grayscale image obtained by the grayscale pixel group including the plurality of grayscale pixels that detect the amount of light received by the light receiving element by the grayscale value of predetermined level.

The edge emphasis processing of the event image on the basis of the edge direction of the subject detected on the basis of the grayscale image is performed as described above, and thus, it is possible to appropriately interpolate only the missing portion of the edge of the subject.

Accordingly, the accuracy of the edge emphasis processing of the event image can be improved.

Furthermore, in the signal processing device as the embodiment, in a case where two event detection pixels are present separately from each other via the event non-detection pixel in the edge direction detected on the basis of the grayscale image, the first edge emphasis section performs the edge emphasis by replacing the event non-detection pixel with the event detection pixel.

Therefore, the edge of the subject in the event image can be appropriately emphasized on the basis of the edge direction of the subject detected on the basis of the grayscale image.

Moreover, in the signal processing device as the embodiment, the first edge emphasis section inputs the information indicating the edge emphasis unit area, which is the unit area in which the edge of the subject is detected, among the unit areas when a grayscale-dependent image (interframe difference image or binarized image), which is the image based on the grayscale image, is divided by using the unit area (As) including the predetermined plurality of pixels as the division units, and performs the edge emphasis processing only on the unit area corresponding to the edge emphasis unit area in the event image.

Therefore, the edge emphasis of the event image is not unnecessarily performed up to the unit area in which the edge is not detected on the grayscale-dependent image side.

Accordingly, the accuracy of the edge emphasis processing for the event image can be improved.

Moreover, in the signal processing device according to the embodiment, the first edge emphasis section performs the edge emphasis processing for every unit area of the event image on the basis of the edge direction detected for every edge emphasis unit area.

Therefore, a processing unit of edge emphasis becomes a unit for every unit area including a predetermined plurality of pixels, and it is possible to realize efficient edge emphasis processing for reducing a calculation load required for edge emphasis.

Furthermore, in the signal processing device (sensor section 1, 1A, or 1B, or event sensor section 1I) as the embodiment, the grayscale-dependent image is the interframe difference image of the grayscale image.

Since only the subject as the moving body is detected in the interframe difference image, the edge emphasis unit area in this case is set as the unit area in which only the edge of the subject as the moving body is detected.

Accordingly, it is possible to prevent the edge emphasis of the event image from being performed in response to an unnecessary edge such as the edge of the subject in the background portion, and it is possible to improve the accuracy of the edge emphasis.

Moreover, in the signal processing device (sensor section 1C) as the embodiment, the grayscale-dependent image is the binarized image.

The edge detection is performed on the binarized image, and thus, it is possible to prevent the edge of the subject in the background portion from being detected.

Accordingly, it is possible to prevent the edge emphasis of the event image from being performed in response to the unnecessary edge, and it is possible to improve the accuracy of the edge emphasis.

Moreover, the signal processing device (sensor section 1A) according to the embodiment includes the second edge emphasis section (edge emphasis section 17) that performs the edge emphasis processing on the grayscale image or the grayscale-dependent image that is the image based on the grayscale image on the basis of the edge direction of the subject detected on the basis of the event image. The first edge emphasis section performs the edge emphasis processing on the event image on the basis of the edge direction detected on the basis of the image edge-emphasized by the second edge emphasis section.

Therefore, the mutual edge interpolation between the event image side and the grayscale image side is realized.

Accordingly, the accuracy of the edge emphasis processing of the event image can be further improved.

Furthermore, in the signal processing device (sensor section 1B) as the embodiment, the first edge emphasis section (edge emphasis section 15B) performs the edge emphasis processing on the event image on the basis of the edge detection result of the subject based on the grayscale image and the edge detection result of the subject based on the event image.

The edge emphasis processing using not only the edge detection result based on the grayscale image but also the edge detection result based on the event image is performed, and thus, it is possible to improve the accuracy of the edge emphasis processing of the event image.

Moreover, the signal processing device according to the embodiment further includes the communication section (13 or 131) that outputs the edge emphasis-related information as the metadata of the event image. The edge emphasis-related information is information related to the edge emphasis processing performed by the first edge emphasis section.

Therefore, in a case where image processing using the event image as the input image is performed at the subsequent stage, it is possible to output, as the metadata of the event image, the edge emphasis-related information as the information or the like indicating in which area of the event image the edge emphasis processing is performed, for example, to an execution section of the image processing.

Accordingly, the execution section of the image processing in the subsequent stage can execute corresponding processing for improving the accuracy of the image processing, improving the processing efficiency, and the like, such as selecting a method of the image processing on the basis of the edge emphasis-related information, for example, on the basis of the evaluation result of the image reliability according to the presence or absence of the edge emphasis, or excluding the image area in which the edge emphasis is not performed as the area in which the subject is not present. As a result, it is possible to improve the accuracy and the processing efficiency of the image processing performed by using the event image as the input image.

Moreover, in the signal processing device according to the embodiment, the first edge emphasis section inputs the information indicating the edge emphasis unit area that is the unit area in which the edge of the subject is detected among the unit areas obtained by dividing the grayscale-dependent image that is the image based on the grayscale image by using the unit area including the predetermined plurality of pixels as the division units, and performs edge emphasis processing on only the unit area corresponding to the edge emphasis unit area in the event image, and the edge emphasis-related information includes at least one of the information indicating which unit area in the event image is the edge emphasis unit area or the information indicating the presence or absence of the edge emphasis for every unit area in the event image.

Therefore, in a case where image processing using the event image as the input image is performed at the subsequent stage, the execution section of the image processing can perform the corresponding processing based on the information indicating which unit area is the edge emphasis unit area and the information indicating the presence or absence of the edge emphasis for every unit area in the event image.

Accordingly, it is possible to improve the accuracy and the processing efficiency of the image processing performed by using the event image as the input image.

Furthermore, in the signal processing device (sensor section 1, 1A, 1B, or 1C) as the embodiment, the event detection pixel group and the grayscale pixel group are formed in the same image array section (1a).

Therefore, when the edge emphasis processing of the event image is performed on the basis of the edge direction detected on the basis of the grayscale image, it is not necessary to perform the coordinate alignment processing between the grayscale image and the event image.

Accordingly, it is possible to reduce the processing load in realizing the edge emphasis processing of the event image.

Moreover, the signal processing device as the embodiment includes the edge detection section (emphasis area and emphasis direction detection section 14 or 14C) that detects the edge direction on the basis of the grayscale image.

That is, the first edge emphasis section that performs the edge emphasis processing of the event image and the edge detection section that detects the edge direction of the subject on the basis of the grayscale image are provided in the same signal processing device.

Therefore, it is not necessary to adopt the configuration in which the information in the edge direction used for the edge emphasis processing of the event image is transferred from another device to the signal processing device, and it is possible to eliminate the need to perform the communication processing with the external device in implementing the edge emphasis processing of the event image, and to reduce the processing load.

The signal processing method as the embodiment is the signal processing method in which the signal processing device inputs the event image that is the image indicating the event detection result by the event detection pixel group including the plurality of event pixels that detect, as the event, the change in the amount of light received by the light receiving element by the predetermined amount or more, and performs edge emphasis processing on the event image on the basis of the edge direction of the subject detected on the basis of the grayscale image obtained by the grayscale pixel group including the plurality of grayscale pixels that detect the amount of light received by the light receiving element by the grayscale value of predetermined level.

With such a signal processing method, it is possible to obtain actions and effects similar to those of the signal processing devices as the above-described embodiments.

Furthermore, the sensor device (sensor section 1, 1A, 1B, or 1C, or event sensor section 1I) as the embodiment includes the pixel array section (1a or 1a′) in which the event detection pixel group including the plurality of event pixels that detect, as the event, the change in the amount of light received by the light receiving element by the predetermined amount or more is formed, and the first edge emphasis section (edge emphasis section 15 or 15B) that receives the event image, which is the image indicating the event detection result by the event detection pixel group in the pixel array section, and performs edge emphasis processing on the event image on the basis of the edge direction of the subject detected on the basis of the grayscale image obtained by the grayscale pixel group including the plurality of grayscale pixels that detect the amount of light received by the light receiving element by the grayscale value of predetermined level.

Even with such a sensor device, it is possible to obtain actions and effects similar to those of the signal processing device as the above-described embodiment.

Note that, the effects described in the present specification are merely examples and are not limited, and other effects may be provided.

### 6. Present Technology

Note that, the present technology can also have the following configurations.
(1) A signal processing device including
a first edge emphasis section that inputs an event image that is an image indicating an event detection result by an event detection pixel group including a plurality of event pixels that detect, as an event, a change in an amount of light received by a light receiving element by a predetermined amount or more, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.
(2) The signal processing device according to the above (1),
in which, in a case where two event detection pixels are present separately from each other via an event non-detection pixel in the edge direction detected on a basis of the grayscale image, the first edge emphasis section performs edge emphasis by replacing the event non-detection pixel with the event detection pixel.
(3) The signal processing device according to the above (1) or (2),
in which the first edge emphasis section
inputs information indicating an edge emphasis unit area that is a unit area in which an edge of the subject is detected, among unit areas when a grayscale-dependent image that is an image based on the grayscale image is divided into unit areas including a predetermined plurality of pixels as division units, and performs the edge emphasis processing only on a unit area corresponding to the edge emphasis unit area in the event image.
(4) The signal processing device according to the above (3),
in which the first edge emphasis section
performs the edge emphasis processing for every unit area of the event image on a basis of the edge direction detected for every edge emphasis unit area.
(5) The signal processing device according to the above (3) or (4),
in which the grayscale-dependent image is an interframe difference image of the grayscale image.
(6) The signal processing device according to the above (3) or (4),
in which the grayscale-dependent image is a binarized image.
(7) The signal processing device according to any one of the above (1) to (6), further including
a second edge emphasis section that performs edge emphasis processing for the grayscale image or a grayscale-dependent image that is an image based on the grayscale image on a basis of the edge direction of the subject detected on a basis of the event image,
in which the first edge emphasis section
performs the edge emphasis processing on the event image on a basis of the edge direction detected on a basis of an image edge-emphasized by the second edge emphasis section.
(8) The signal processing device according to any one of the above (1) to (7),
in which the first edge emphasis section
performs the edge emphasis processing on the event image on a basis of an edge detection result of the subject based on the grayscale image and an edge detection result of the subject based on the event image.
(9) The signal processing device according to any one of the above (1) to (8), further including
a communication section that outputs, as metadata of the event image, edge emphasis-related information that is information related to the edge emphasis processing by the first edge emphasis section.
(10) The signal processing device according to the above (9),
in which the first edge emphasis section
inputs information indicating an edge emphasis unit area that is a unit area in which an edge of the subject is detected, among unit areas when a grayscale-dependent image that is an image based on the grayscale image is divided into unit areas including a predetermined plurality of pixels as division units, and performs the edge emphasis processing only on a unit area corresponding to the edge emphasis unit area in the event image, and
the edge emphasis-related information
includes at least one of information indicating which unit area in the event image is the edge emphasis unit area or information indicating presence or absence of edge emphasis for every unit area in the event image.
(11) The signal processing device according to any one of the above (1) to (10),
in which the event detection pixel group and the grayscale pixel group are formed in a same image array section.
(12) The signal processing device according to any one of the above (1) to (11) further including
an edge detection section that detects the edge direction on a basis of the grayscale image.
(13) A signal processing method including
inputting, by a signal processing device, an event image that is an image indicating an event detection result by an event detection pixel group including a plurality of event pixels that detect, as an event, a change in an amount of light received by a light receiving element by a predetermined amount or more, and performing edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.
(14) A sensor device including
a pixel array section in which an event detection pixel group including a plurality of event pixels that detect, as an event, a change in an amount of light received by a light receiving element by a predetermined amount or more is formed, and
a first edge emphasis section that inputs an event image that is an image indicating an event detection result by the event detection pixel group in the pixel array section, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

### REFERENCE SIGNS LIST

100, 100D Imaging device
1, 1A, 1B, 1C Sensor section
1S Grayscale sensor section
1I Event sensor section
1a Pixel array section
20g Event pixel
10gr, 10gg, 10gb Grayscale pixel
Gu, Gu′ Pixel unit
2 Image use processing section
2a Communication section
2b Region-of-interest use processing section
2c Region-of-interest detection processing section
3 Communication section
10 Grayscale image generation section
11 Image signal processing section
12 Luminance signal conversion section
13, 13S, 13I Communication section
14, 14C Emphasis area and emphasis direction detection section
15, 15B Edge emphasis section
16 Emphasis area and emphasis direction detection section
17 Edge emphasis section
20 Event image generation section
21 X arbiter
22 Y arbiter
23 Event processing circuit
24 Output I/F
31 Logarithmic conversion section
32 Buffer
33 Event detection circuit
34 Subtractor
35 Quantizer
36 Output control and reset circuit
37p Positive-electrode-side memory
37m Negative-electrode-side memory
38 Output circuit
39 OR circuit
40 Delayer

1. A signal processing device comprising:
a first edge emphasis section that inputs an event image that is an image indicating an event detection result by an event detection pixel group including a plurality of event pixels that detect, as an event, a change in an amount of light received by a light receiving element by a predetermined amount or more, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

2. The signal processing device according to claim 1,
wherein, in a case where two event detection pixels are present separately from each other via an event non-detection pixel in the edge direction detected on a basis of the grayscale image, the first edge emphasis section performs edge emphasis by replacing the event non-detection pixel with the event detection pixel.

3. The signal processing device according to claim 1,
wherein the first edge emphasis section
inputs information indicating an edge emphasis unit area that is a unit area in which an edge of the subject is detected, among unit areas when a grayscale-dependent image that is an image based on the grayscale image is divided into unit areas including a predetermined plurality of pixels as division units, and performs the edge emphasis processing only on a unit area corresponding to the edge emphasis unit area in the event image.

4. The signal processing device according to claim 3,
wherein the first edge emphasis section
performs the edge emphasis processing for every unit area of the event image on a basis of the edge direction detected for every edge emphasis unit area.

5. The signal processing device according to claim 3,
wherein the grayscale-dependent image is an interframe difference image of the grayscale image.

6. The signal processing device according to claim 3,
wherein the grayscale-dependent image is a binarized image.

7. The signal processing device according to claim 1, further comprising:
a second edge emphasis section that performs edge emphasis processing for the grayscale image or a grayscale-dependent image that is an image based on the grayscale image on a basis of the edge direction of the subject detected on a basis of the event image,
wherein the first edge emphasis section
performs the edge emphasis processing on the event image on a basis of the edge direction detected on a basis of an image edge-emphasized by the second edge emphasis section.

8. The signal processing device according to claim 1,
wherein the first edge emphasis section
performs the edge emphasis processing on the event image on a basis of an edge detection result of the subject based on the grayscale image and an edge detection result of the subject based on the event image.

9. The signal processing device according to claim 1, further comprising:
a communication section that outputs, as metadata of the event image, edge emphasis-related information that is information related to the edge emphasis processing by the first edge emphasis section.

10. The signal processing device according to claim 9,
wherein the first edge emphasis section
inputs information indicating an edge emphasis unit area that is a unit area in which an edge of the subject is detected, among unit areas when a grayscale-dependent image that is an image based on the grayscale image is divided into unit areas including a predetermined plurality of pixels as division units, and performs the edge emphasis processing only on a unit area corresponding to the edge emphasis unit area in the event image, and
the edge emphasis-related information
includes at least one of information indicating which unit area in the event image is the edge emphasis unit area or information indicating presence or absence of edge emphasis for every unit area in the event image.

11. The signal processing device according to claim 1,
wherein the event detection pixel group and the grayscale pixel group are formed in a same image array section.

12. The signal processing device according to claim 1, further comprising:
an edge detection section that detects the edge direction on a basis of the grayscale image.

13. A signal processing method comprising:
inputting, by a signal processing device, an event image that is an image indicating an event detection result by an event detection pixel group including a plurality of event pixels that detect, as an event, a change in an amount of light received by a light receiving element by a predetermined amount or more; and performing edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.

14. A sensor device comprising:
a pixel array section in which an event detection pixel group including a plurality of event pixels that detect, as an event, a change in an amount of light received by a light receiving element by a predetermined amount or more is formed, and
a first edge emphasis section that inputs an event image that is an image indicating an event detection result by the event detection pixel group in the pixel array section, and performs edge emphasis processing on the event image on a basis of an edge direction of a subject detected on a basis of a grayscale image obtained by a grayscale pixel group including a plurality of grayscale pixels that detect an amount of light received by a light receiving element by a grayscale value of a predetermined level.
